(19) United States
(12) Patent Application Publication
(10) Pub. No.: US 2008/0076892 A1
(43) Pub. Date: Mar. 27, 2008

(54) Telomer compositions and production processes

(76) Inventors: Bruno Ameduri, Montpellier (FR); George K. Kostov, Montpellier (FR); Stephan Brandstadter, Indianapolis, IN (US); E. Bradley Edwards, Lafayette, IN (US)

Correspondence Address: WELLS ST. JOHN P.S., 601 W. FIRST AVENUE, SUITE 1300, SPOKANE, WA, 99201, US

(21) Appl. No.: 11/890,082

(22) Filed: Aug. 3, 2007

Related U.S. Application Data
(60) Provisional application No. 60/835,645, filed on Aug. 3, 2006.

(51) Int. Cl. C08F 12/20

(52) U.S. Cl. 526/243; 526/242; 526/245; 526/249; 528/392

(57) ABSTRACT

Telomer compositions are provided that can include at least one taxogen unit and a telogon unit, the taxogen unit being one or more of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, and propylene; the telogen unit being one or more of R_{F}Q or R_{Cl}Q, wherein the R_{F} group can be an alkyl group having at least four fluorine atoms, the R_{Cl} group can be —CCl₃, and the Q group can be H, Br, or I. Chemical production processes are also provided that can include exposing a taxogen to a telogen to form a telomer.

### RELATED PATENT DATA

This patent claims priority to U.S. provisional patent application 60/835,645 which was filed Aug. 3, 2006, entitled “Compositions, Halogenated Compositions, Chemical Production, Telomerizaton, and Cotelomerization Processes” and which is incorporated by reference herein.

### TECHNICAL FIELD

The disclosure pertains to compositions, halogenated compositions, chemical production and telomerization processes.

### BACKGROUND

Compositions such as surfactants, polymers, and urethanes have incorporated halogenated functional groups. These functional groups have been incorporated to affect the performance of the composition when the composition is used as a treatment for materials and when the composition is used to enhance the performance of materials. For example, surfactants incorporating halogenated functional groups can be used as fire extinguishants either alone or in formulations such as aqueous film forming foams (AFFF). Polymers and/or urethanes incorporating halogenated functional groups have also been used to treat materials. To prepare these compositions, halogenated intermediate compositions can be synthesized.

### DRAWINGS

Embodiments of the disclosure are described below with reference to the following accompanying drawings.

FIG. 1A is a diagram of a system according to an example embodiment of an example aspect of the disclosure.

FIG. 1 is analytical data of a composition according to an embodiment.

FIG. 2 is analytical data of a composition according to an embodiment.

FIG. 3 is analytical data of a composition according to an embodiment.

FIG. 4 is analytical data of a composition according to an embodiment.

FIG. 5 is analytical data of a composition according to an embodiment.

FIG. 6 is analytical data of a composition according to an embodiment.

FIG. 7 is analytical data of a composition according to an embodiment.

FIG. 8 is analytical data of a composition according to an embodiment.

FIG. 9 is analytical data of a composition according to an embodiment.

FIG. 10 is analytical data of a composition according to an embodiment.

FIG. 11 is analytical data of a composition according to an embodiment.

FIG. 12 is analytical data of a composition according to an embodiment.

FIG. 13 is analytical data of a composition according to an embodiment.

FIG. 14 is analytical data of a composition according to an embodiment.

FIG. 16 is analytical data of a composition according to an embodiment.

FIG. 17 is analytical data of a composition according to an embodiment.

FIG. 18 is analytical data of a composition according to an embodiment.

FIG. 19 is analytical data of a composition according to an embodiment.

FIG. 20 is analytical data of a composition according to an embodiment.

### DESCRIPTION

This disclosure of the invention is submitted in furtherance of the constitutional purposes of the U.S. Patent Laws “to promote” the progress of science and useful arts” (Article 1, Section 8).

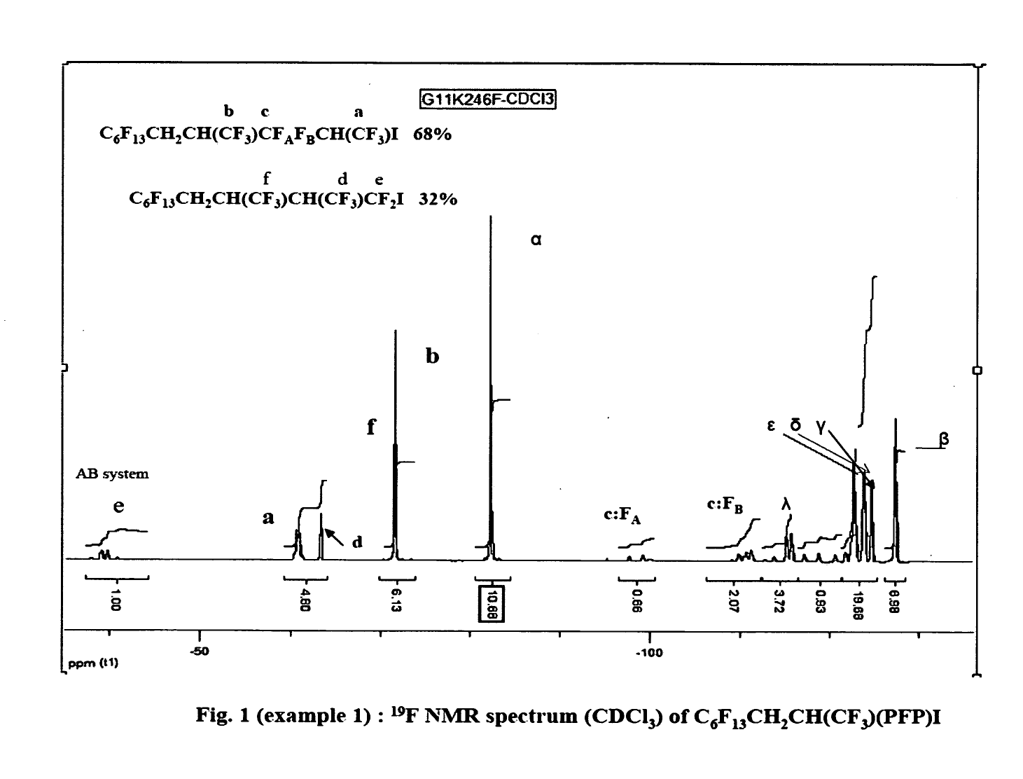

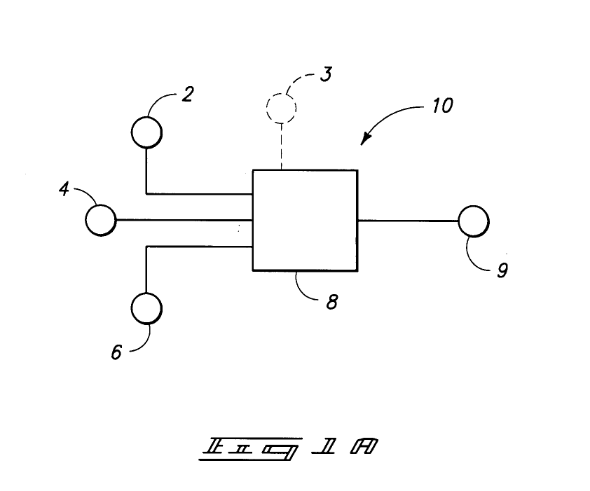

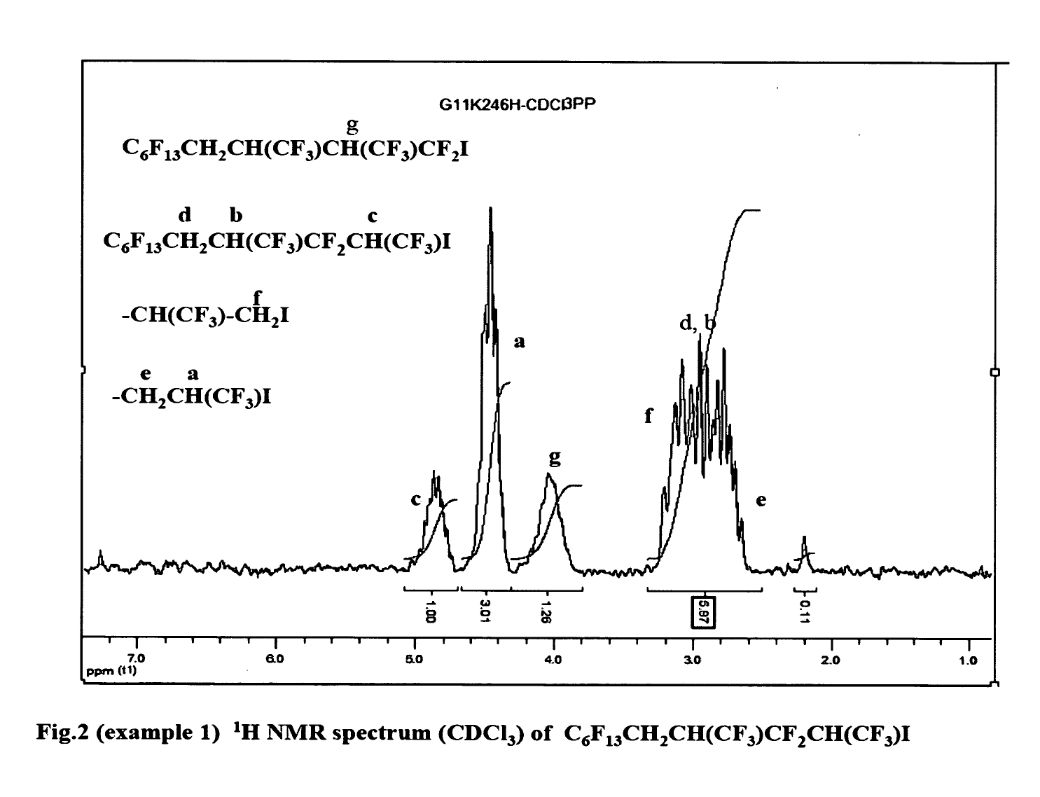

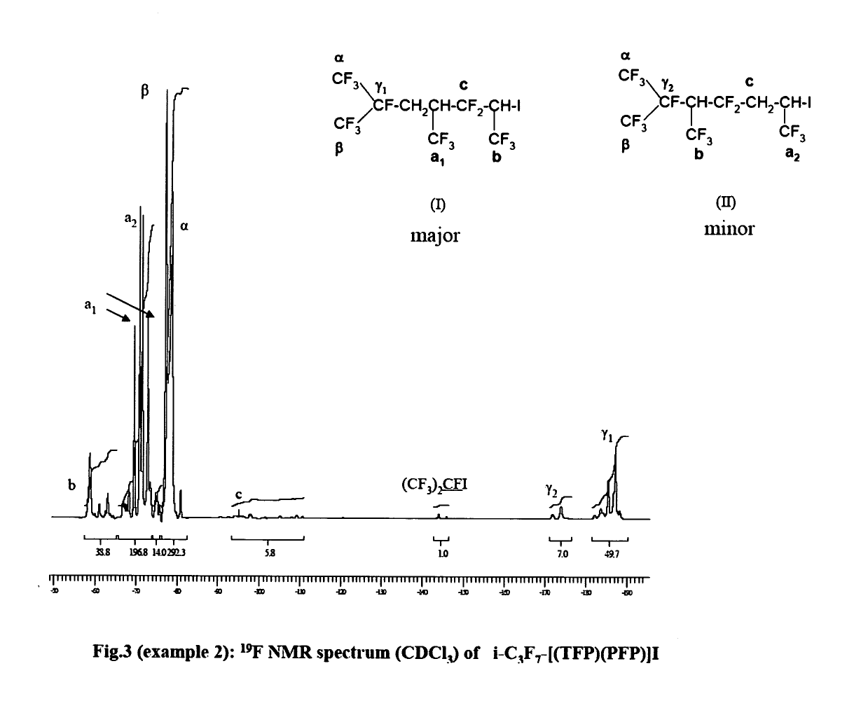

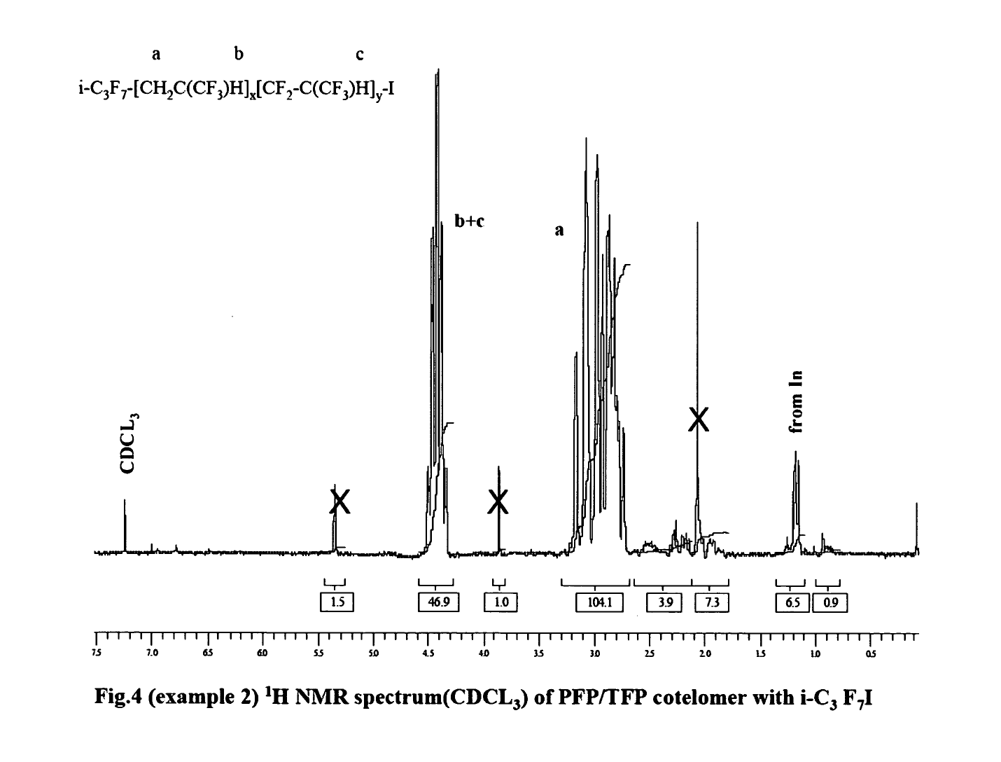

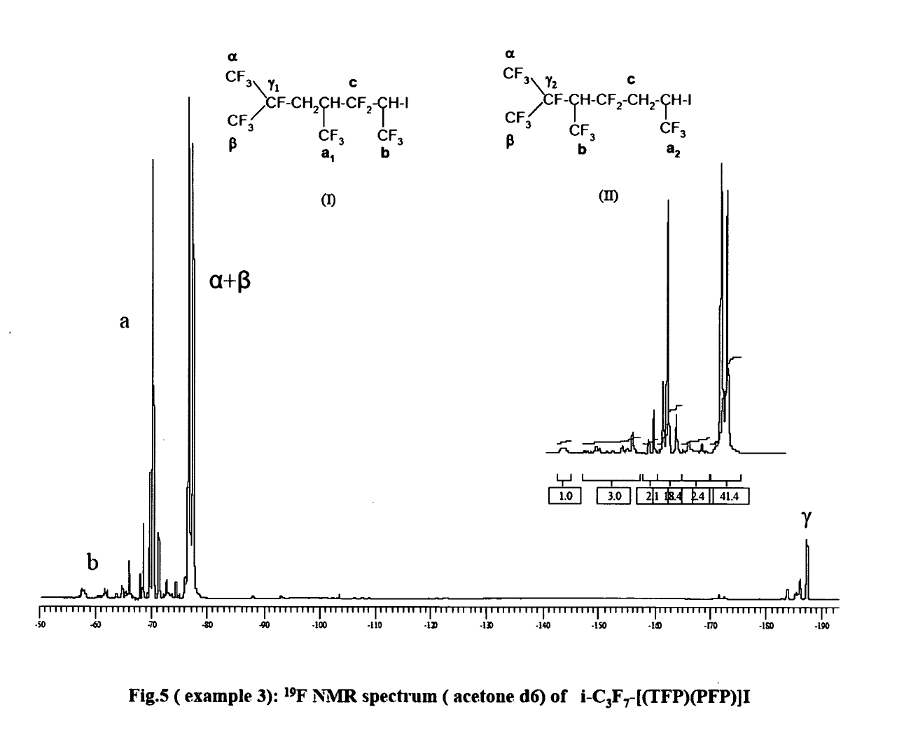

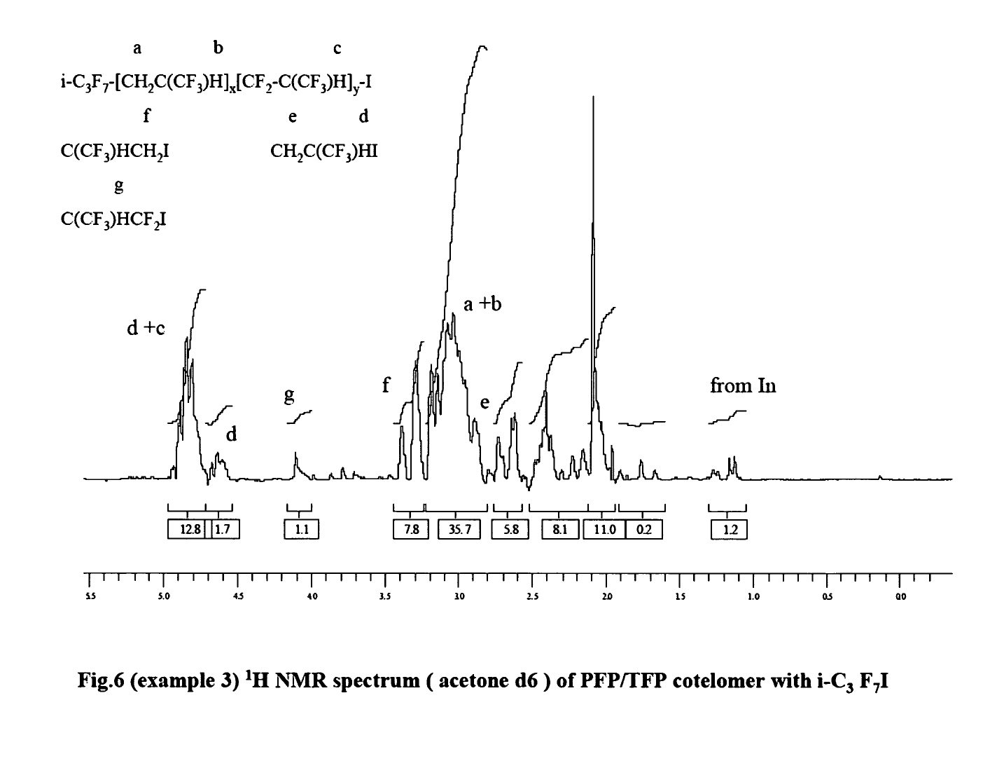

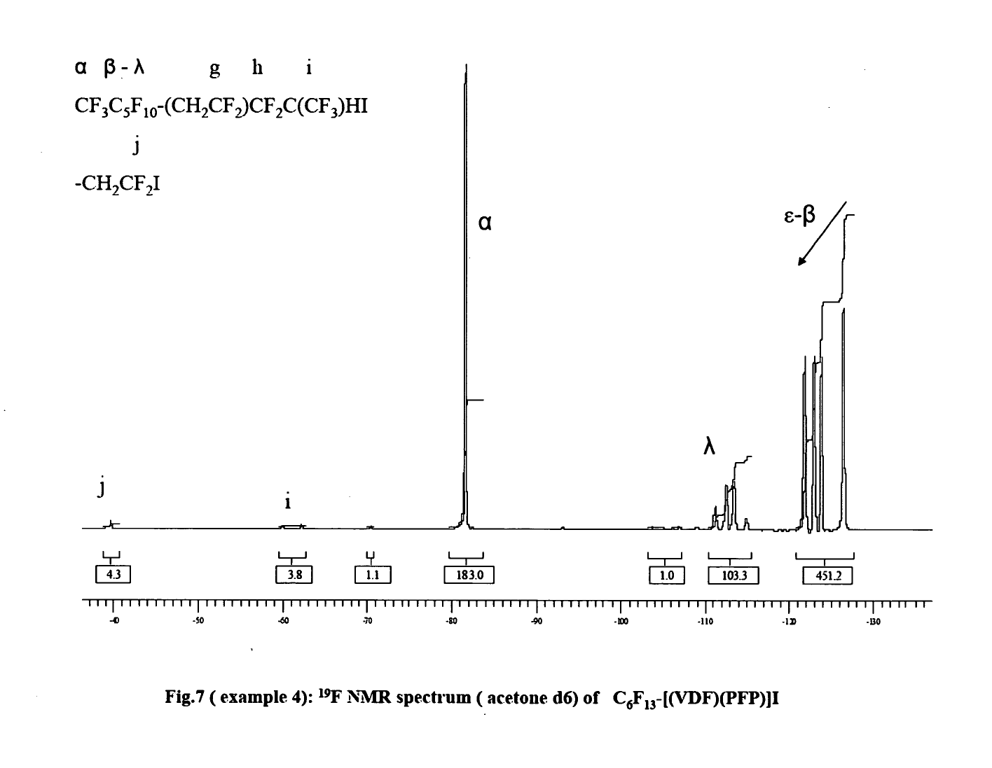

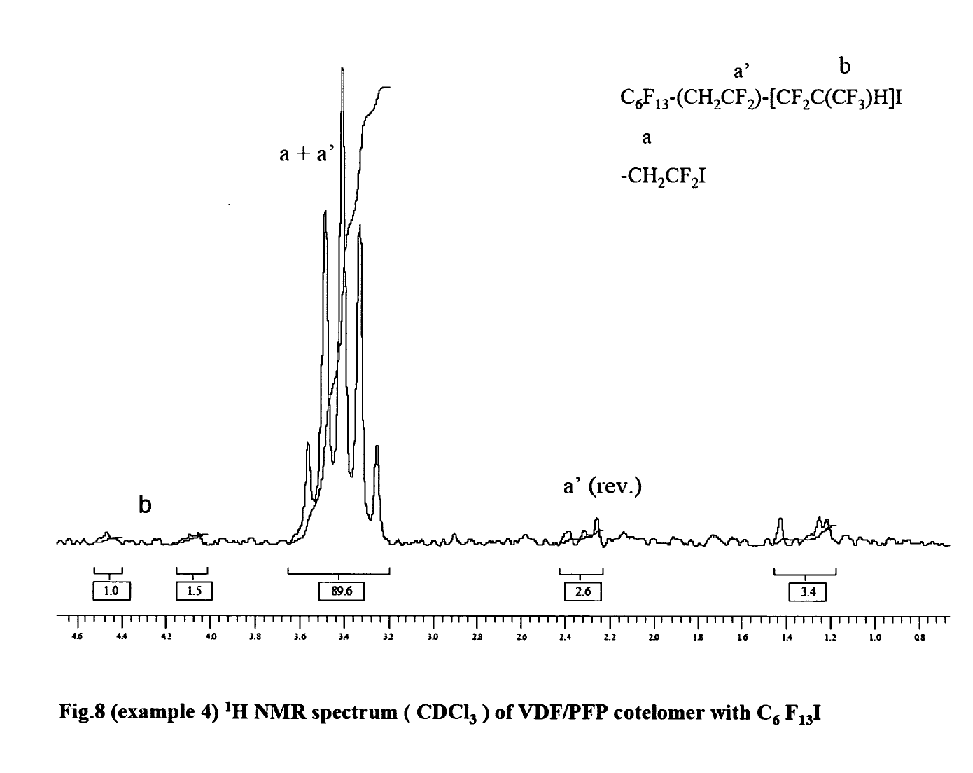

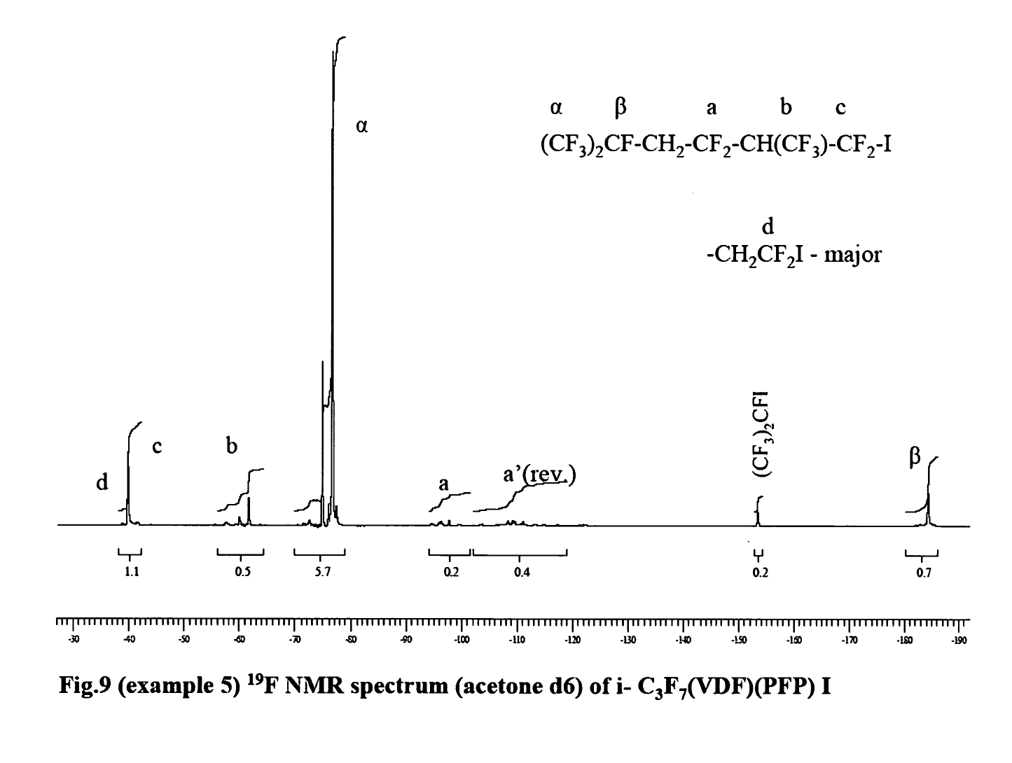

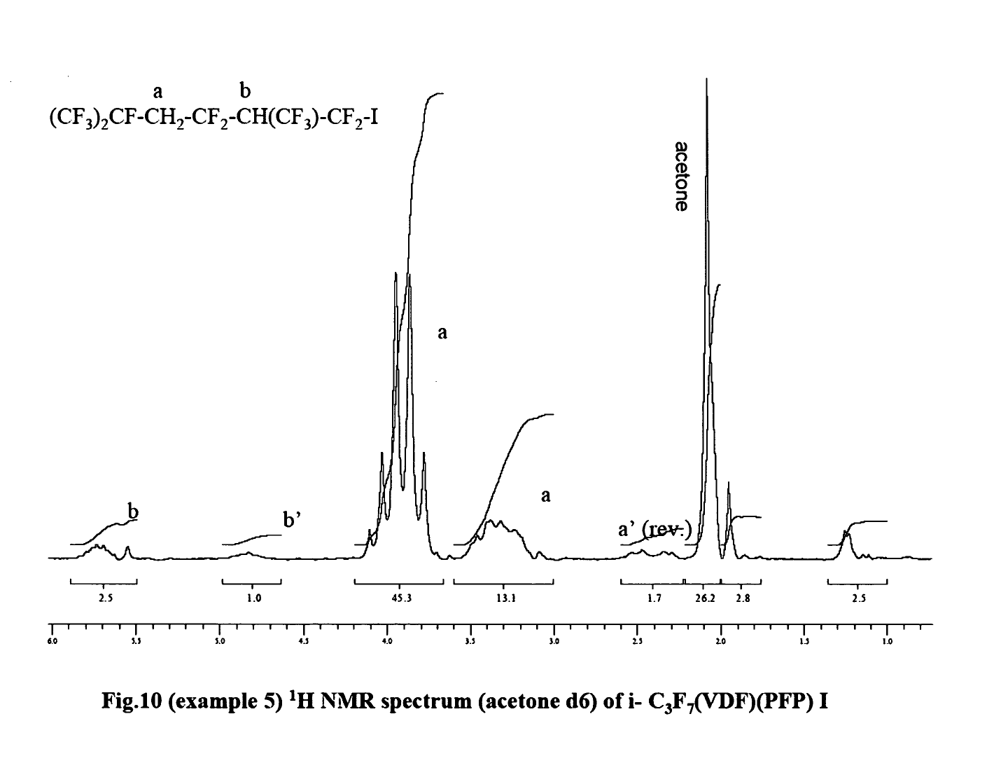

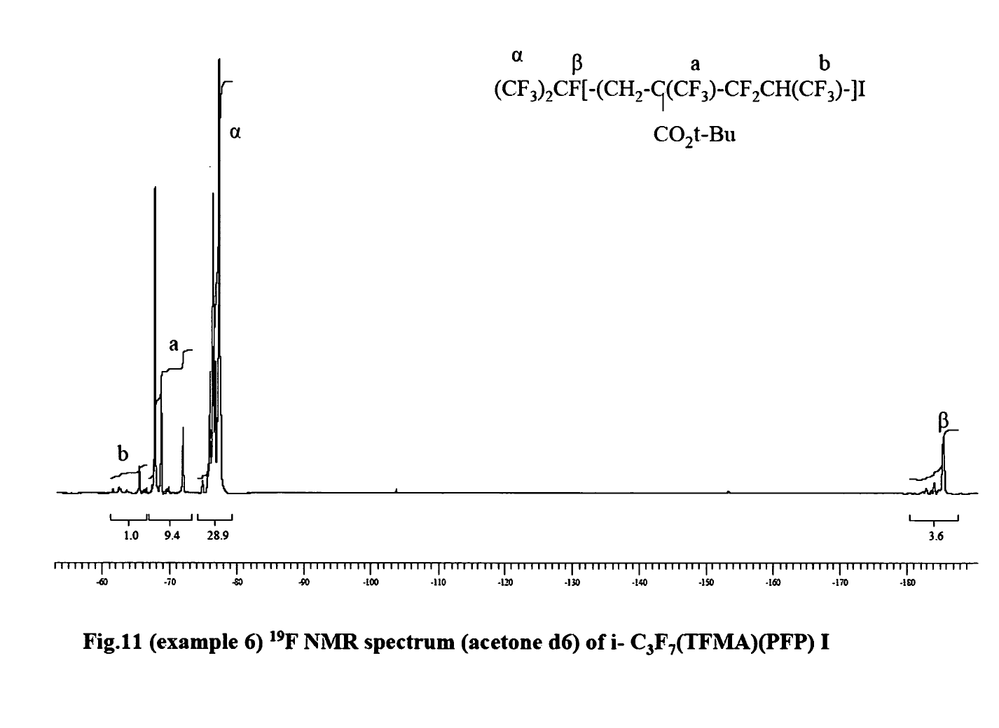

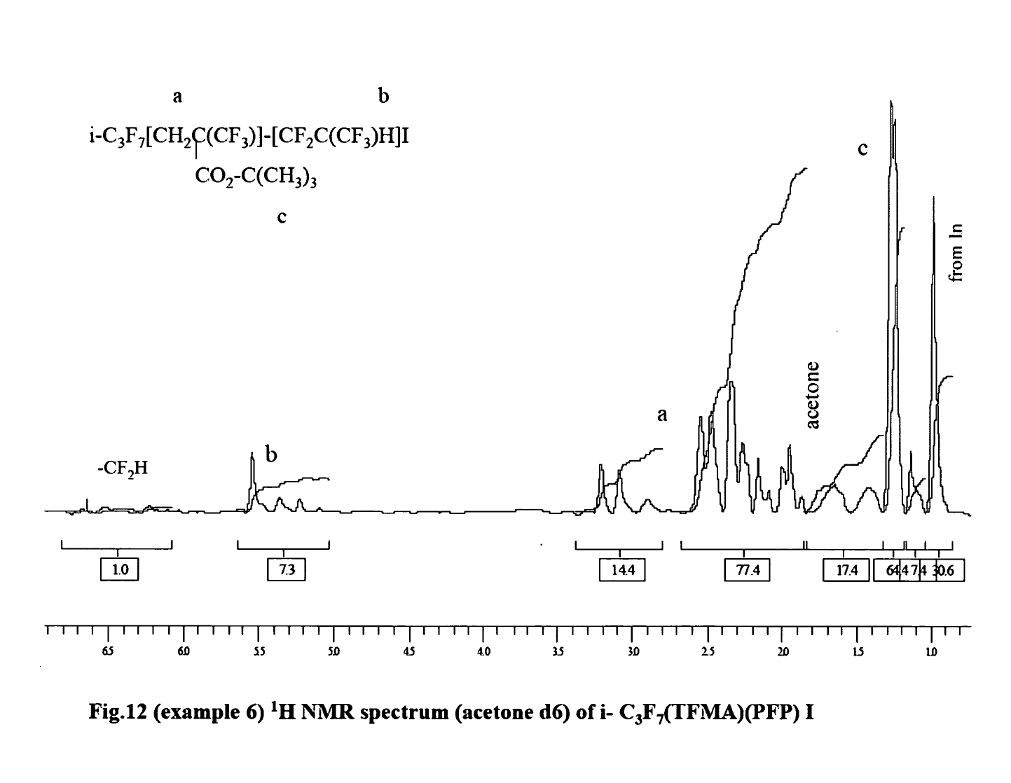

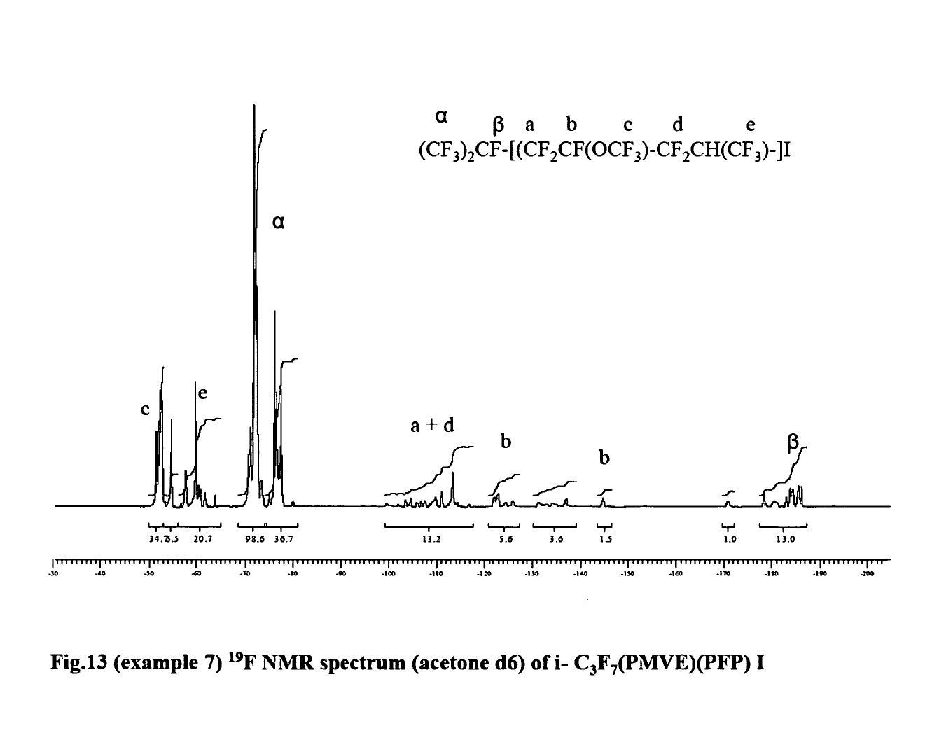

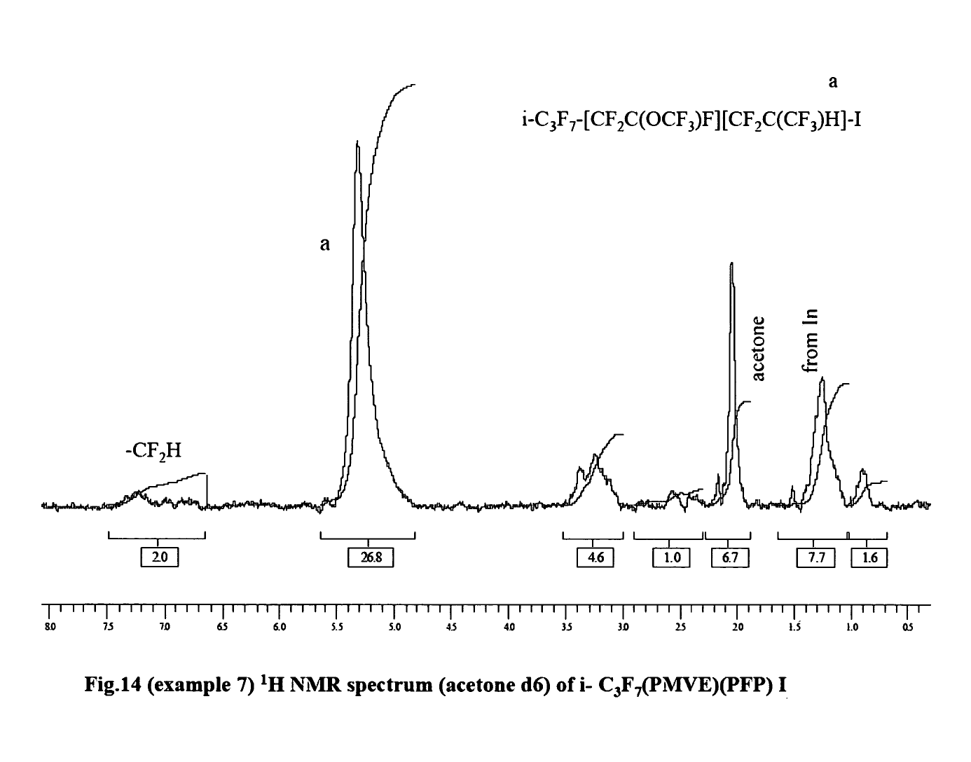

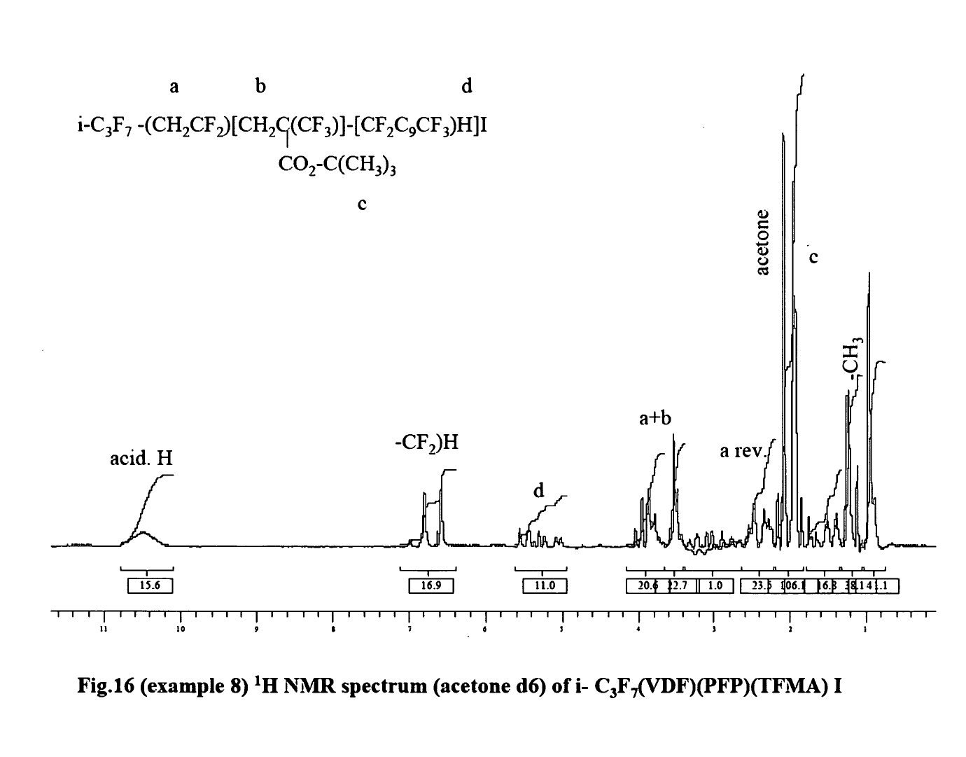

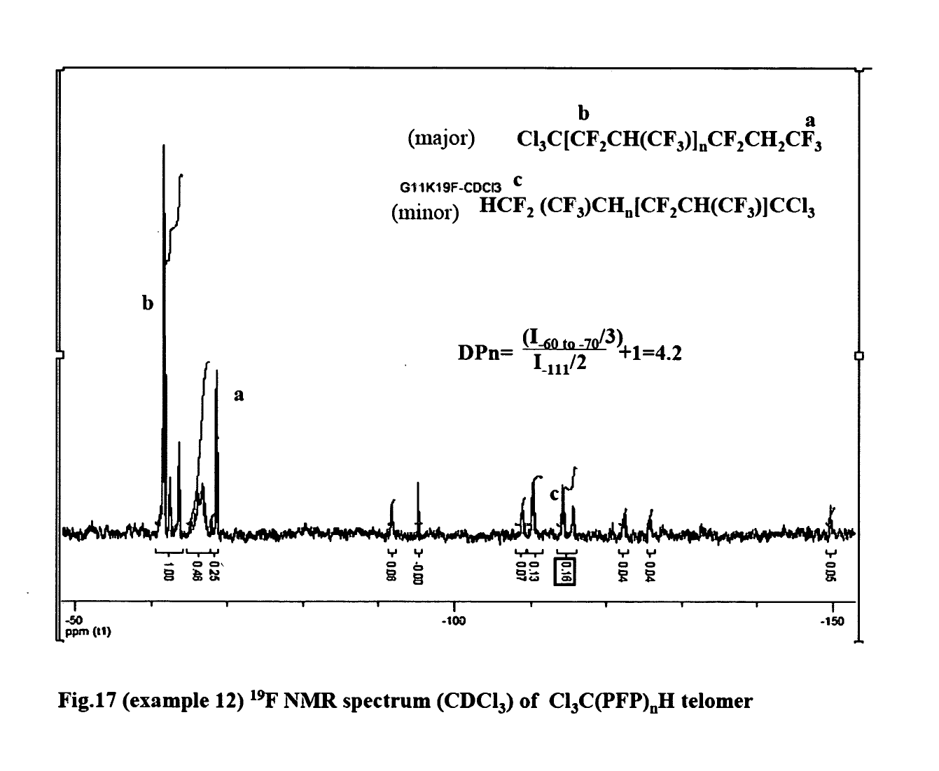

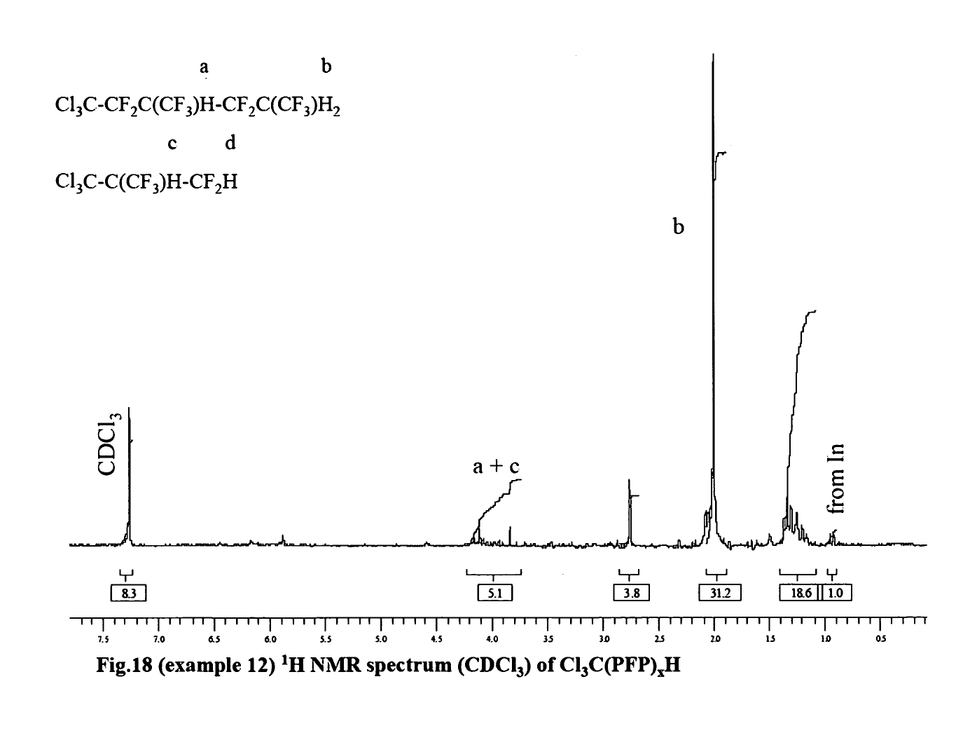

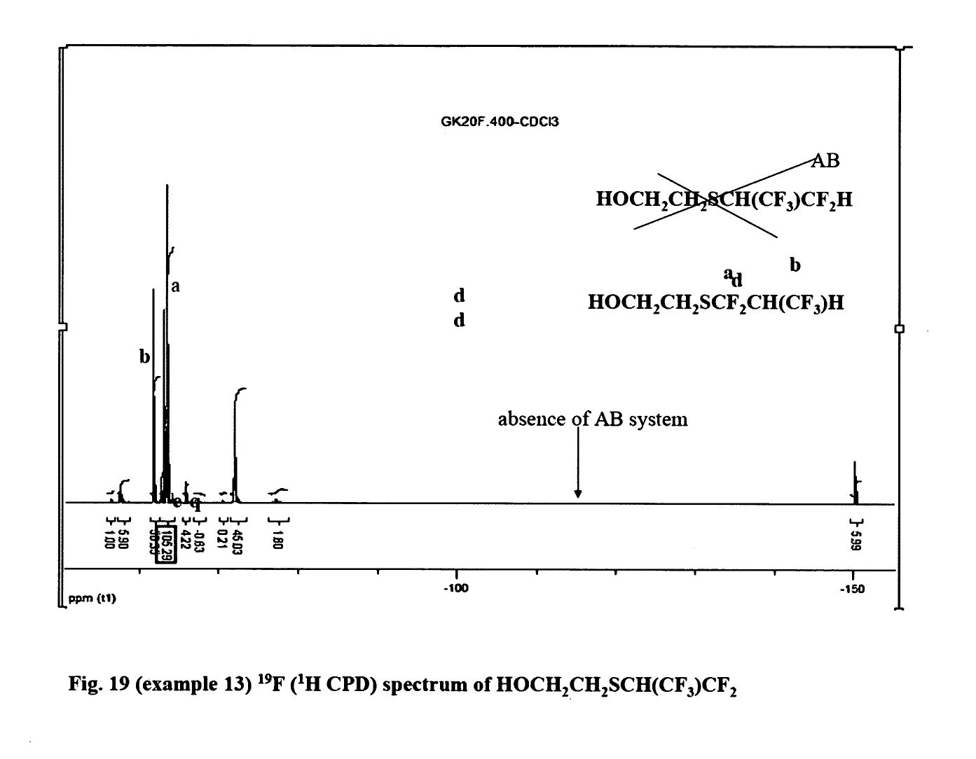

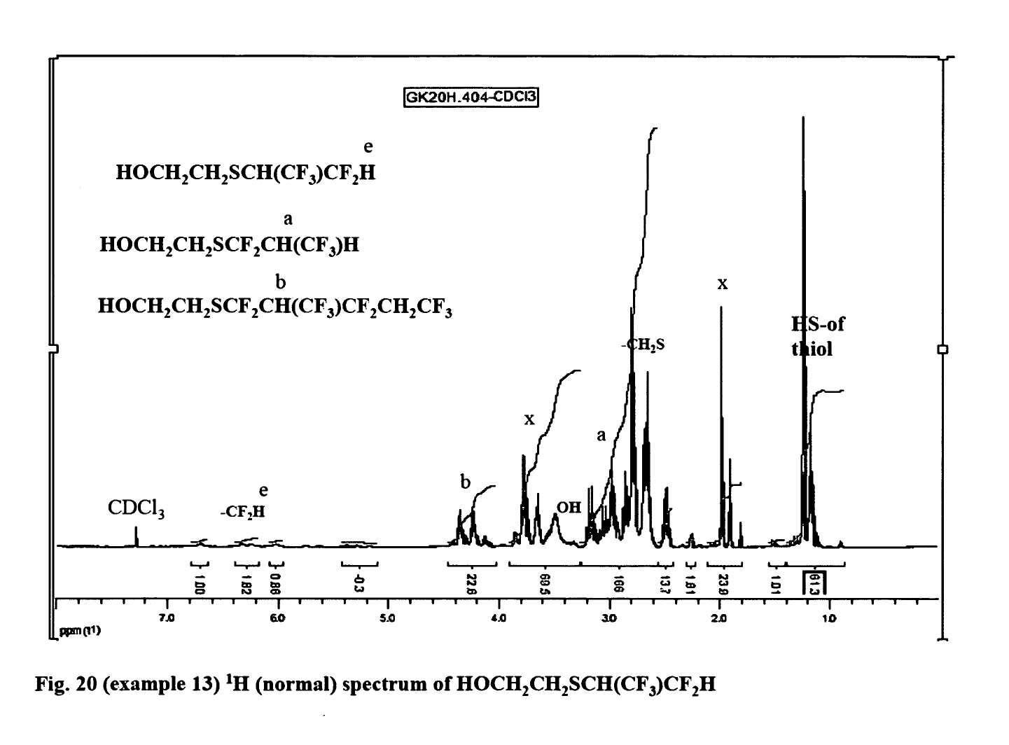

Compositions and methods of making compositions are described with reference to FIGS. 1A-20. Referring to the FIG. 1A, a system 10 is shown for preparing halogenated compositions that can include taxogen vessels 2 and 3, a telogen vessel 4, and an initiator vessel 6 all coupled to reactor 8 to form a product that is to be provided to telomer vessel 9. In example embodiments system 10 can configured to perform a telomerization process. The system can be comprised by vessels, reactors, and/or conduits that are appropriate for telomerization processes such as Radical cotelomerization processes. The processes can include the telomerization of fluorinated compounds such as fluorinated monomers. The flow of reagents from vessels 2, 3, 4, and 6 to reactor 8 and from reactor 8 to vessel 9 can all be controlled utilizing valves and flow meters not shown but within the knowledge of a person of ordinary skill in the chemical production arts.

According to an embodiment, taxogen vessel 2 can be exposed to telogen 4 to form telomer 9. In accordance with another embodiment, taxogen 2 can be exposed to telogen 4 in the presence of initiator 6. Reactor 8 can also be configured to provide heat to the reagents during the exposing. As the examples indicate these the taxogens and telogens are combined to form a telomer having respective taxogen and telogen units. As as example a telomer produced by combining the taxogen PFP with the telogen C₃F₇I will have a PFP taxogen unit and a C₃F₇I telogen unit.

Taxogens 2 and/or 3 can include at least one CF₃-comprising compound. The CF₃-comprising compound can have a C-2 group having at least one pendant —CF₃ group. According to example embodiments, taxogen 2 can comprise an olefin, such as 3,3,3-trifluoropropene (TFP, trifluoropropene). Example taxogens can also include 1,1,1,3,3-pentafluoropropene (PFP, pentafluoropropene), vinylidene fluoride (VDF, H₂C═CF₂), tert-butyl-α-trifluoromethyl acrylate (TFMA), and perfluoromethyl ether (PMVE).

Taxogens can also include vinyl fluoride (VF, H₂C═CFH), tetrafluoroethylene (TFE F₂C═CF₂), chloro-trifluoroethylene (CTFE, CF₂═CFCl), bromo-trifluoroethylene (BrTFE, CF₂═CFBr), trifluoroethylene (TFE, CF₂═CFH), dichloro-difluoroethylene (CFCl═CFC₁, CF₂═CCl₂), hexafluoropropylene (HFP, F₂C═CFCF₃), chloro-difluoroethylene (F₂C═CHCl), bromo-difluoroethylene (F₂C═CHBr), ethylene-alkyl ethers (H₂C═CHOR with R being an alkyl group such as —CH₃), ethylene (H₂C═CH₂), and/or propylene (H₂C═CHCH₃). Additional taxogens can include those listed in Table 1 below.

TABLE 1
Example Taxogens

| | |
|---|---|
| 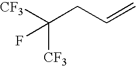 | 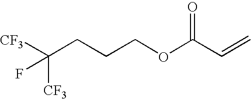 |
| 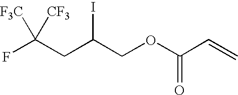 | 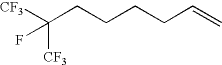 |
| 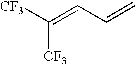 | 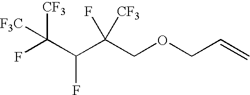 |
| 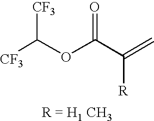 | 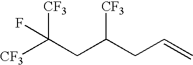 |
| 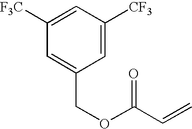 | 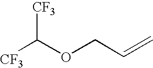 |
| 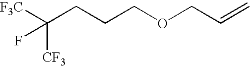 | 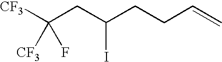 |
| 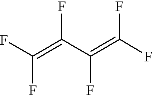 | 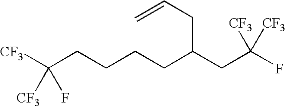 |
| 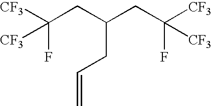 | 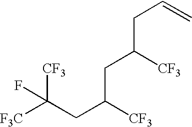 |
| 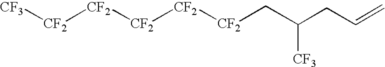 | 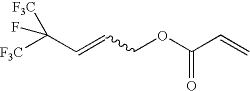 |
| 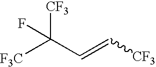 | 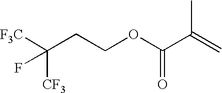 |
| 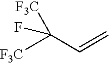 | 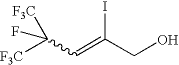 |
| 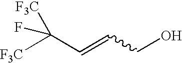 | 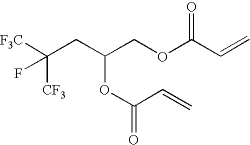 |
| 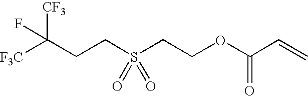 | 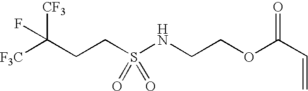 |
| 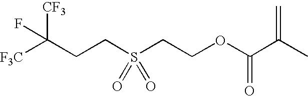 | 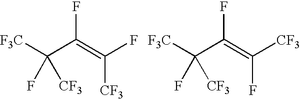 |
| 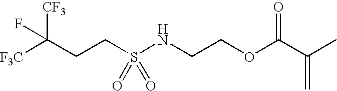 | 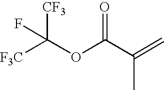 |
| 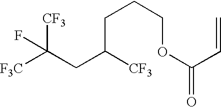 | 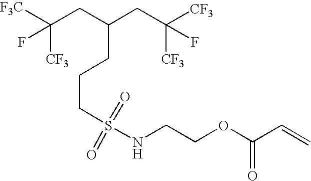 |
| 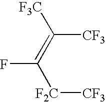 | 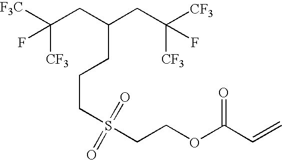 |
| 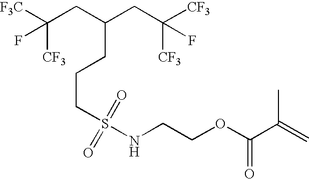 | 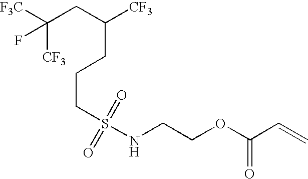 |
| 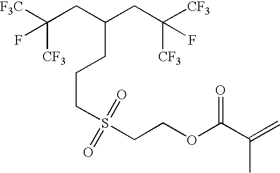 | 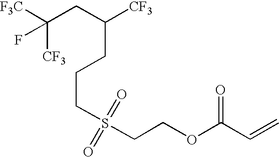 |
| 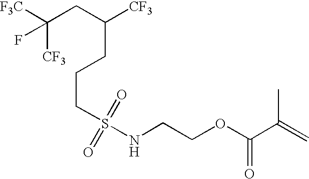 | 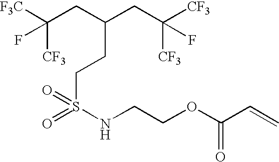 |
| 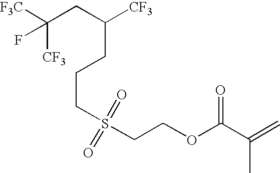 | 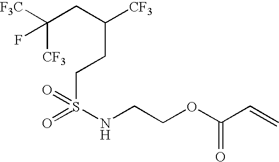 |
| 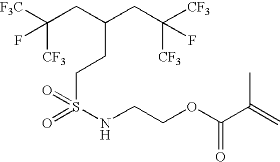 | 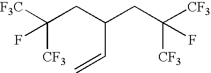 |
| 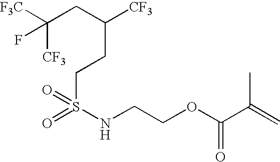 | 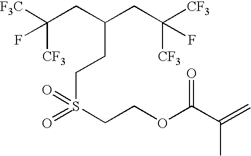 |
| 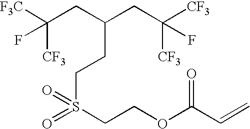 | 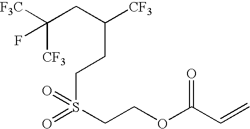 |
| 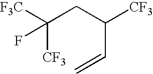 | 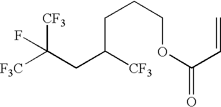 |
| 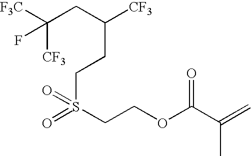 | 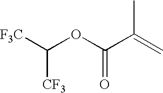 |
| 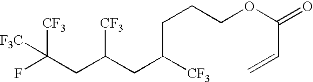 | 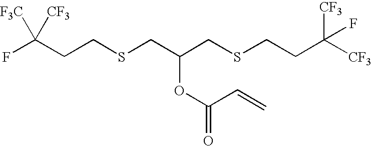 |
| 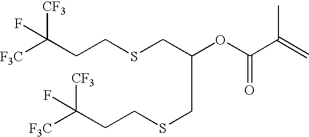 | 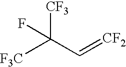 |
| 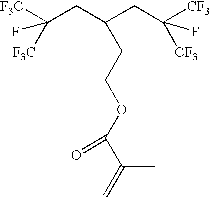 | 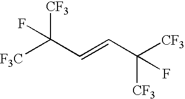 |
| 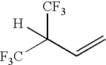 | 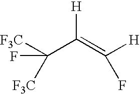 |
| CF₃—CH═CH—CF₃ | 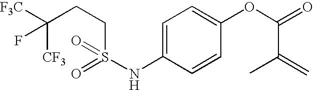 |

Taxogen 2 can also include more than one compound. For example, taxogen 2 can be a mixture of compounds such as multiple taxogens. These taxogens can be provided as a mixture to reactor 8, for example. According to example embodiments, additional taxogen may be provided to reactor 8 from vessel 3. Taxogen may be interchangeably provided from either or both of vessels 2 and/or 3, for example. According to alternative embodiments additional taxogens may be provided to reactor 8 from reagent vessel 3. The amount of taxogen provided to reactor 8 from vessels 2 and/or 3 may be controlled via flow meters for example.

Telogen 4 can include halogens such as, iodine, fluorine, bromine, and/or chlorine. Telogen 4 can include at least four fluorine atoms and can be represented as R_{F}Q and/or R_{Cl}Q. The R_{F} group can include at least four fluorine atoms and the Q group can include one or more atoms of the periodic table of elements. The Q group can be H or I with the R_{F} group being a C₃F₇ group such as (CF₃)₂CF— and/or —C₆F₃, for example. The R_{Cl} group can include at least one —CCl₃ group. Example telogens can include 1,1,1,2,3,3,3-heptafluoro-2-iodopropane ((CF₃)₂CFI or i-C₃F₇I), 1,1,1,2,2,3,3,4,4,5,5,6,6-tridecafluoro-6-iodohexane (C₆F₁₃I), trichloromethane, HP(O)(OEt)₂, BrCFClCF₂Br, R—SH and/or R—OH(R being a group comprising at least one carbon), and/or MeOH. Additional example telogens can include bromotrichloromethane, chloroform, mercaptoethanol, and/or dibromochlorotrifluoroethane (BrCF₂CFClBr). Further example telogens can include, but are not limited to: 1,2-dichloro-2-iodo-trifluoroethane (ClCF₂CFICl); RSC(S)X, X being C₆H₅, OR′ (R′ being and alkyl group), or SR with R being an alkyl group; RS—SR, with R being an alkyl group; (Y)₃SiH, Y being OR or Cl with R being an alkyl group; I(C₂F₄)ₙ(CH₂CF₂)a(C₃F₆)_{b}I, n=1, 2, 3, a=1-6, and b=0-2; CₙF₂ₙ₊₁CF₂CFICF₃, CₙF₂ₙ₊₁CF₂CFIH, or CₙF₂ₙ₊₁CFHCF₂I, with n=1, 2, 3, 4, 6, 8, 10 and/or multiples of 2; CF₃SO₂SC₆H₁₁; and/or CF₃SO₂SC₆H₅.

According to example embodiments, an initial mole ratio of taxogen to telogen can be from about 1:1 to about 1:10, 1:4 to about 4:1, and/or to about 2:1 to about 4:1. The taxogens may be exposed to the telogens in the presence of a solvent such as C₄F₅H₅, CH₃CN and/or mixtures both, for example. Additional example telogens are those shown below in Table 2.

TABLE 2
Example Telogens

| | |
|---|---|
| 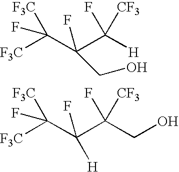 | 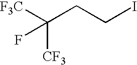 |
| 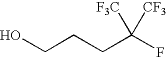 | 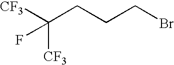 |
| 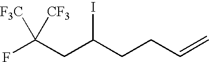 | 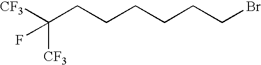 |
| 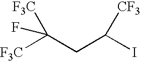 | 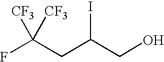 |
| 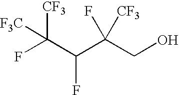 | 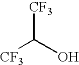 |
| 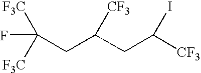 | 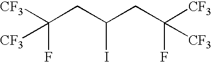 |
| 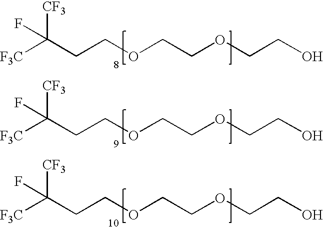 | 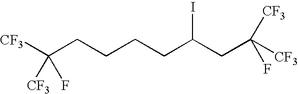 |
| 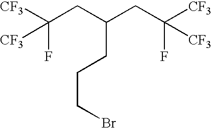 | 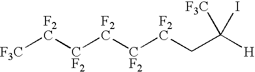 |
| 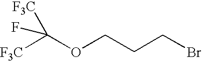 | 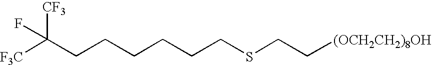 |
| 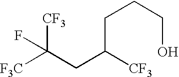 | 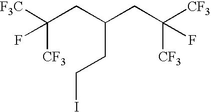 |
| 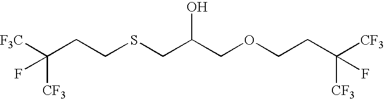 | 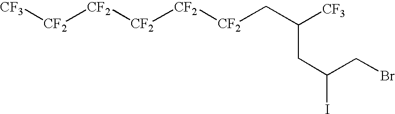 |
| 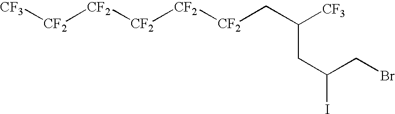 | 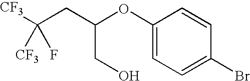 |
| 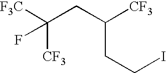 | 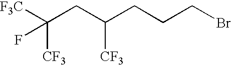 |
| 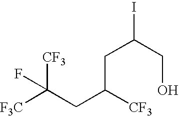 | 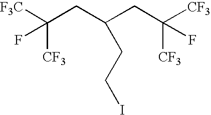 |
| 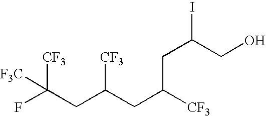 | 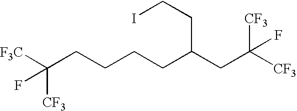 |
| 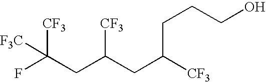 | 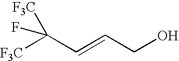 |
| 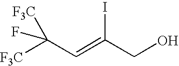 | 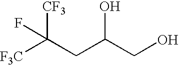 |
| 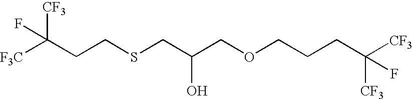 | 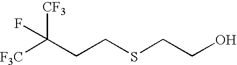 |
| 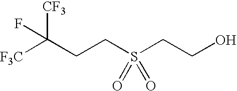 | 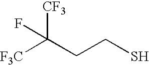 |
| 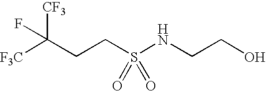 | 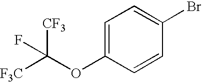 |
| 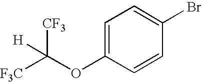 | 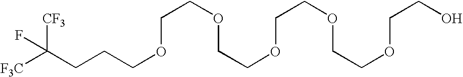 |
| 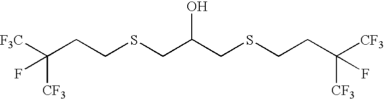 | 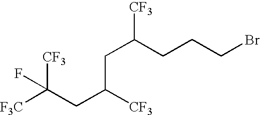 |
| 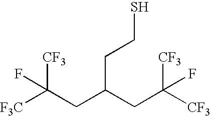 | 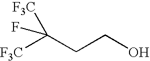 |
| 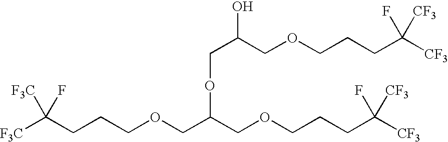 | 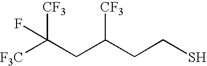 |
| 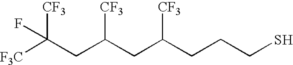 | 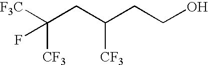 |
| 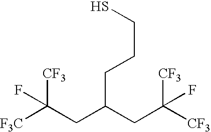 | 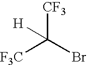 |
| 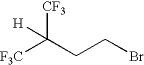 | 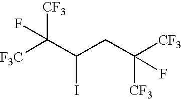 |
| 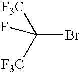 | 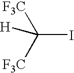 |
| 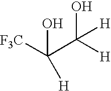 | 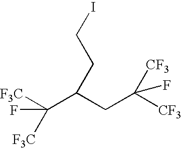 |
| 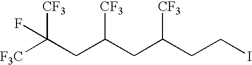 | 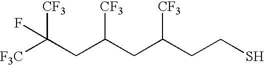 |
| 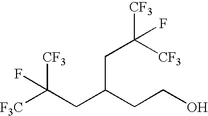 | 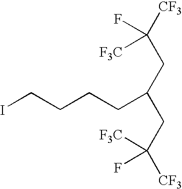 |
| 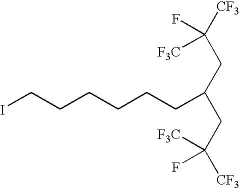 | 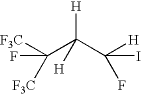 |
| 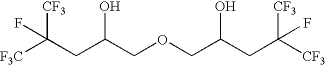 | 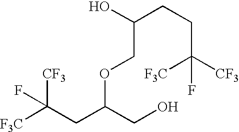 |
| 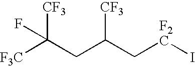 | 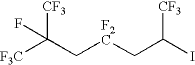 |
| 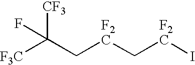 | 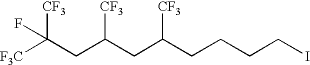 |

According to example implementations, in vessel 2 can be taxogens such as PFP and TFP as well, and telogen C₆ F₁₃I can be provided to reactor 8 with or without the C₄F₅H₅ as a solvent. According to other implementations taxogens PFP and VDF as well as telogen C₆F₁₃I can be provided to reactor 8. Taxogens PFP and TFMA as well as C₃F₇I, such as i-C₃F₇I, may also be provided to reactor 8. PFP and PMVE can also be provided to reactor 8 along with C₃F₇I. According to other implementations, PFP, VDF, and TFMA may be provided to reactor 8 with C₃F₇I and with or without C₄F₅H₅ as a solvent in reactor 8. As another example, the taxogen PFP may be provided to reactor 8 as well as the telogen diethyl phosphate HP(O)(OEt)₂. The taxogen PFP may also be provided from a taxogen vessel to reactor 8 as well as bromotrichloromethane and/or chloroform as a telogen with or without CH₃CN as a solvent. PFP may also be provided to reactor 8 as well as the telogen mercaptoethanol, with or without CH₃CN as a solvent. As another example, the taxogen PFP may be provided to reactor 8 as well as the telogen dibromochlorotrifluoroethane BrCF₂CFClBr.

Reactor 8 can be any lab-scale or industrial-scale reactor and, in certain embodiments, reactor 8 can be configured to control the temperature of the reagents therein. According to example embodiments reactor 8 can be used to provide a temperature during the exposing of the reagents of from about 130° C. to about 150° C.

Telomer 9, produced upon exposing taxogen 2 to telogen 4, can include R_{Tel}(R_{Tax})ₙQ. The R_{Tel} group can include portions of the telogens used to produce the telomer. For example, R_{Tel} of the telogen C₆F₁₃I can be the C₆F₁₃— group. The R_{Tax} group can include portions of the taxogens used to produce the telomer. For example, R_{Tax} of the taxogen TFP can be the 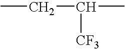
group. The number of groups represented by the general telomer formula is given as n, n can be 4, for example. In accordance with example implementations, n can be greater than one and R_{Tax} can be derived from the same taxogen such as a dimer of TFP, for example —CH₂CH(CF₃)CH₂CH(CF₃)—, which can also be referred to as a diadduct. According to other implementations R_{Tax} can be derived from different taxogens such as PFP and TFP, for example —CF₂CH(CF₃)CH₂CH(CF₃)—, sometimes referred to as a diadduct as well.

In additional embodiments initiator 6 may be provided to reactor 8 during the exposing of the reagents. Initiator 6 can include thermal, photochemical (UV, for example), radical, and/or metal complexes, for example, including one or more peroxides including di-tert-butyl peroxide. Initiator 6 can also include catalysts, such as Cu. Initiator 6 and telogen 4 can be provided to reactor 8 at an initial mole ratio of initiator 6 to taxogen 2 of from between about 0.001 to about 0.05 and/or from between about 0.01 to about 0.03, for example.

Telomerizations utilizing photochemical and/or metal-complex initiators 6 can be carried out in batch conditions using Carius tube reactors 8 under high pressures, if desirable. Telomerizations using metal-complexes can also be performed within autoclave reactors under high pressure. Telomerizations utilizing thermal and/or peroxide initiators 6 can be carried out in 160 and/or 500 cm³, or even larger volume, such as 2 L, Hastelloy® (HAYNES INTERNATIONAL, INC, P.O. BOX 9013 1020 WEST PARK AVENUE KOKOMO INDIANA 46904-901) reactors 8. The telomer product mixture can be analyzed by gas chromatography and/or the product can be distilled into different fractions and analyzed by ¹H and ¹⁹F NMR and/or ¹³C NMR. In accordance with the following examples, telomers can be prepared and/or derivitized.

### EXAMPLE 1

### Radical Cotelomerization of 2H-pentafluoropropene and 3,3,3-trifluoropropene (TFP) with C₆F₁₃I

A 160-mL Hastelloy (HC-276) autoclave reactor that can be equipped with inlet and outlet valves, a manometer and a rupture disc, can be charged with 89.2 g (0.20 mole) of C₆F₁₃I and 0.9 g (0.0061 mole) of di-tert-butylperoxide (DTBP). The reactor can be cooled in an ice bath at 0° C. and purged with inert gas such as nitrogen or argon for 15 min. The reactor can be closed and pressurized with 30 bar of nitrogen to check eventual leaks. The reactor can be chilled to about −80° C. using an Acetone/liquid nitrogen bath for example. The reactor can be vacuum/argon purged/pressurized 5-6 times. About 24.0 g (0.18 mole) of PFP and 3.0 g (0.003 moles) of TFP (85/15 mol %) can be introduced to the reactor and the reactor heated up to 143° C. A reactor pressure can be observed to increase to about 21.2 bars and stabilize to about 19.5 bars after 5 hours. The reactor can be placed in an ice bath for about 60 minutes and 13.7 g of non-reacted PFP and TFP can be progressively released (the conversion of the monomers can be about 51.9 wt %). The autoclave can be opened and about 95.1 g of what can be observed as a brown liquid can be obtained and distilled (distillation yield Y_{d}=39.7 wt %). The total product mixture can comprise (assessed by gas chromatography (GC)): 45.9% of non-reacted C₆F₁₃I (retention time RT=1.3 min), 24.2% of PFP/TFP monoadduct (RT=2.9-3.3 min and b.p.=65-70° C. at 20 mm Hg) and 3.5% diadduct (RT=4.8 min, b.p.=105° C. at 20 mm Hg). The mono- and diadduct were characterized by ¹⁹F and ¹H NMR spectroscopy and the molar ratio of PFP/TFP in cotelomer (C₆F₁₃CH₂CH(CF₃)CF₂CHICF₃ and C₆F₁₃CH₂CH(CF₃)CH(CF₃)CF₂I) can be determined to be 68/32 mole %.

¹H NMR (CDCl₃, ppm): δ: 4.8 (quint. AB-X system, C*H, ³J_{HF}=³J_{HHA}=15 Hz; ³J_{HHB}=7 Hz; 4.2 (—CH₂C*H(CF₃)I); 4.0 (—C*H(CF₃)CF₂I); 3.2-2.65 centr. 2.9 m, H_{A}, H_{B} in AB system R_{F} CH₂; 2H); 3.1 (C*H(CF₃)CH₂I); 2.9 (C*H(CF₃)CF₂—); 2.8 (CH₂C*H(CF₃)I).

¹⁹F NMR (CDCl₃, ppm): δ: −39 q (—C*H(CF₃)CF₂I); −61 (CF₂C*H(CF₃)I; −63.5 (—C*H(CF₃)—); −72.8, −71.6 (—CH₂C*HCF₃CF₂—); −82.3 (t, J=9.5 Hz, α CF₃, 3F; −98 to −99 (—CH(CF₃)CF_{A}CF_{B}CH(CF₃)—; −109 to −111 (—CF_{A}F_{B}CH(CF₃)—; −113.7 (mCF₂CH₂, λ2F); −121.6 (m, CF₂CH₂, ε2F); −122.8 (m, —C₂F₅CF₂CF₂, δ2F); −123.6 (m, —C₂H₅CF₂, γ2F); −126.6 (m, CF₃CF₂-β 2F).

### EXAMPLE 2

### Radical Cotelomerization of 2H-pentafluoropropene and 3,3,3-trifluoropropene with i-C₃F₇I

In the same reactor and with the same conditions as in example 1, the reactor can be charged with 44.8 g (0.15 mole of (CF₃)₂CFI and 0.8 g (0.006 mole) of DTBP. About 21.0 g (0.16 mole) of PFP and 4.0 g (0.04 mole) of TFP (80/20 mol %) can be provided to the reactor. The pressure may be observed to reach 22.5 bars and stabilize to 20.2 bars for 5 hours. About 18.0 g of PFP and TFP remained non-reacted (conversion rate of 28.0 wt %). About 36.8 g of what can be observed as a brown liquid can be obtained and distilled (Y_{d}=20 wt %). The total product mixture can comprise (assessed by GC): i-C₃F₇I=25.2%; 8.9 wt % of TFP monoadduct (RT=1.3 min, b.p.=25° C. at 20 mm Hg). The PFP/TFP molar ratio in the cotelomer (i-C₃F₇CH₂CH(CF₃)CF₂CHICF₃ with minor i-C₃F₇CF₂CH(CF₃)CH₂CHICF₃) can be found to be 16.2/83.8 mol %.

¹H NMR (CDCl₃, ppm): δ: centr. 4.4, m 1H, C*H in TFP and PFP; 3.25 (—CH(CF₃)CH₂I); centr. 3.0, m 2H in TFP; 2.9 (—CH₂—C*H(CF₃)I); 1.2 CH₃ from initiator).

¹⁹F NMR (CDCl₃, ppm): δ: −61 (CF₂CH(CF₃)I); centr. −71.9 assigned to CF₃ of TFP, a₁ (R_{F}CH₂CH(CF₃)CF₂CH(CF₃)I); −72.3 a₂ (—CH₂CH(CF₃)I); −77.3, m 3F ((CF₃)₂CF—); −77.6 (3F (CF₃)₂CF—, 3J_{FF}=69.5 Hz; −98 to −99 (CF_{A}F_{B} in PFP); −109 to −111 (CF_{A}F_{B} in PFP); −144 non-reacted (CF₃)₂CFI; −175 and −185 γ2 and γ1, 1 F in C(F).

### EXAMPLE 3

### Radical Cotelomerization of 2H-pentafluoropropene and 3,3,3-trifluoropropene with i-C₃F₇I and C₄F₅H₅ as a Solvent

In the same reactor as in example 1 with the same conditions, the reactor can be charged with 12.3 g (0.04 mole) of (CF₃)₂CFI, 0.9 g (0.006 mole) of DTBP and 26.3 g (0.178 mole) of C₄F₅H₅. About 32.0 g (0.242 mole) of PFP and 3.0 g (0.031 mole) of PFP (89/11 mol %) can be provided to the reactor. The pressure can be observed to reach about 18.35 bar and stabilize to 15.7 bar for 5 hours. About 20.0 g of PFP and TFP can remain non-reacted (degree of conversion 42.9 wt %). About 32.7 g of what can be observed as a brown liquid can be obtained and distilled (Y_{d}=30.3 wt %). The total product mixture can comprise (assessed by GC) approximately i-C₃F₇I=6.1%; 20.9 wt % of TFP monoadduct (RT=1.4 min, b.p.=25° C. at 20 mm Hg). The PFP/TFP molar ratio in the cotelomer)i-C₃F₇CH₂CH(CF₃)CF₂CHICF₃ with minor i-C₃F₇CF₂CH(CF₃)CH₂CHICF₃) can be found to be 24.6/75.4 mol %.

¹H NMR (d-acetone, ppm): δ: centr. 4.7-5.0, m 1H, C*H in TFP and PFP; 3.25 (—CH(CF₃) CH₂I); centr. 3.0, m 2H in TFP; 2.9 (—CH₂—C*H(CF₃)I); 1.2 (CH₃ from initiator).

¹⁹F NMR (d-acetone, ppm): δ: −61.8 to −66.1 (CF₃ in PFP); centr. −70.3 assigned to CF₃ of TFP; −76.8 and −77.5 (m 2×CF₃ in ((CF₃)₂CF—); 183.9, −187.4, 1F in C(F).

### EXAMPLE 4

### Radical Cotelomerization of 2H-pentafluoropropene and tert-butyl-α-trifluoromethyl acrylate (TFMA) with i-C₃F₇I

In the same reactor as example 1, the reactor can be charged with 56.0 g (0.19 mole of i-C₃F₇I, 0.83 g (0.006 mole) of DTBP and 7.4 (0.04 mole) of TFMA. About 20.0 g (0.15 mole) of PFP (80/20 mol %) can be provided to the reactor. The pressure can be observed to reach about 26.0 bar and stabilize to about 25.1 bar in 20 hrs. About 10 g of PFP remained non-reacted (degree of conversion vs PFP can be about 50.09 wt %). About 45.0 g of what can be observed as a brown liquid can be acquired and distilled (Y_{d}=32.8 wt %). The total product mixture (assessed by GC) can comprise: i-C₃F₇I=39.2%; 25.2 wt % of PFP monoadduct (RT=1.4 min, b.p.=40-42° C. at 20 mm Hg), 5.4% TFMA monoadduct (RT=2.9 min, b.p.=70° C. at 20 mm Hg), 5.5% PFP/TFMA adduct (RT=4.6 min. b.p.=89° C. at 20 mm Hg) and n≧3 as a residue. The PFP/TFMA molar ratio in the cotelomer (i-C₃F₇[CH₂C(CF₃)(CO₂tBu)]a[CF₂CH(CF₃)]b]I) can be about 9.6/90.4 mol %.

¹H NMR (d-acetone, ppm): δ: centr. 5.5-C*H(CF₃) of PFP; centr. 3.0, 2.5-2.2-CH₂ of TFMA; 1.8-C(CH₃)₃; 1.2 (CH₃) from initiator.

¹⁹F NMR (d-acetone, ppm): δ: −61, −65 (CF₃) of PFP; −67, −69 (CF₃ of TFMA); −74.9 to −77.4 (2×CF₃ of i-C₃F₇—); −182 to −185.6 (—C(F) of i-C₃F₇—).

### EXAMPLE 5

### Radical Cotelomerization of 2H-pentafluoropropene and perfluoromethyl ether (PMVE) with i-C₃F₇I

In the same reactor used in example 1, the reactor can be charged with 44.6 g (0.15 mole of i-C₃F₇I, 0.66 g (0.005 mole) of DTBP. About 16.0 g (0.12 mole) of PFP and 5.0 g (0.03 mole) of PMVE (80/20 mol %) can be provided to the reactor. The pressure can be observed to reach about 29.7 bar and stabilize to about 28.6 bar in 20 hrs. About 12.0 g of PFP and PMVE remained non-reacted (degree of conversion 42.9 wt %). About 21.0 g of what can be observed as a dark brown liquid can be acquired and distilled (Y_{d}=41.4 wt %). The total product mixture (assessed by GC) can comprise: i-C₃F₇I=25.4%; 9.9 wt % of PFP monoadduct (RT=1.4 min, b.p.=40° C. at 20 mm Hg), 12.1% of PMVE monoadduct (RT=2.2-2.3 min, b.p.=48-50° C. at 20 mm Hg), 6.1 wt % of PFP/PMVE adduct (RT=2.8-3.3 min. b.p.=67-72° C. at 20 mm Hg) and n≧3 as a residue. The PFP/PMVE molar ratio in the cotelomer (i-C₃F₇[CF₂CFO(CF₃)]a[CF₂CH(CF₃)]_{b}]cl) can be about 34/66 mol %.

¹H NMR (d-acetone, ppm): δ: centr. 5.4-C*H(CF₃) of PFP.

¹⁹F NMR (d-acetone, ppm): δ: −52.4, −54 (OCF₃) of PMVE; −59.8, −63.8 (CF₃ of PFP); −71.9, −76.2 (2×CF₃ of i-C₃F₇—); m centr. −110 (—CF₂ of PMVE and PFP), −122, −144.8 (—CF (OCF₃), m centr. −182 (—C(F) of i-C₃F₇—).

### EXAMPLE 6

### Tertelomerization of 2H-pentafluoropropene, vinylidene fluoride (VDF) and tert-butyl-α-trifluoromethyl acrylate (TFMA) with i-C₃F₇I and C₄F₅H₅ as a Solvent

In the same reactor as in example 1, the reactor can be charged with 63.8 g (0.22 mole of i-C₃F₇I, 0.34 g (0.002 mole) of DTBP+2.0 g (0.07 mole) of 2,5-bis(tert-butylperoxy)-2,5-dimethylhexane (Trigonox 101), 14.8 g (0.076 mole) of TFMA and 23.2 g (0.157 mole) of C₄F₅H₅. About 10.0 g (0.076 mole) of PFP and 10.0 g (0.156 mole) of VDF (PFP/VDF/TFMA=25.0/50.0/25.0 mol % in the feed) can be provided to the reactor. The pressure can be observed to reach about 30.3 bar and stabilize to about 25.7 bar during 20 hrs. About 13 g of PFP and VDF remained non-reacted (degree of conversion 38.9 wt %). About 84.6 g of what can be observed as a dark brown liquid can be acquired and distilled (Y_{d}=21 wt %). The total product mixture (assessed by GC) can comprise: i-C₃F₇I=10.9%; 30.5 wt % of C₄F₅H₅; 23.5 wt % of VDF monoadduct (RT=1.2 min, b.p.=40° C. at 20 mm Hg), 7.0% of VDF/TFMA adduct (RT=2.7 min, b.p.=46-48° C. at 20 mm Hg), 3.0% of PFP/VDF/TFMA (RT=3.9-4 min, b.p.=89-93° C. at 20 mm Hg) and n≧3 as a residue. The PFP/VDF/TFMA molar ratio in the tertelomer (i-C₃F₇[(CH₂CF₂)x(CH₂C(CF₃)(CO₂tBu))y[CF₂CH(CF₃)]z]wl) can be about 24.9/23.1/52 mol %.

¹H NMR (d-acetone, ppm): δ: m. centr. 5.2-C*H(CF₃); m 4.1-2.8 CH₂ of VDF+ CH₂ of TFMA; 2.2-2.5 (CH₂ of VDF reverse); 1.8, (—C(CH₃)₃); 1.2 CH₃ of TFMA.

¹⁹F NMR (d-acetone, ppm): δ: −40, —CH₂CF₂I; −61, −65 (CF₃ of PFP); t −67.7 (CF₃ of TFMA); −75.7 to −77.6 (2×CF₃ in i-C₃F₇—); −88, −97.3 (—CF₂ of VDF); centr. −184 (—CF of i-C₃F₇—).

### EXAMPLE 7

### Telomerization of 2H-pentafluoropropene with diethyl phosphate HP(O)(OEt)₂ as a Telogen

To a reactor of borosilicate Carius tubes (length 130 mm, internal diameter 10 mm, thickness 2.5 mm, total volume 8 cm³, the reactor) can be provided about 0.017 g (0.00012 mole) of DTBP, 1 ml of CH₃CN as an inert solvent and about 0.445 g (0.0032 mole) of HP(O)(OEt)₂. The reactor can be connected to a vacuum line, frozen under liquid nitrogen and purged several times by evacuating and flushing with helium (“freeze-thaw cycling”). About 0.3038 g (0.00227 mole) of PFP can be provided to the reactor from the calibrated line. The reactor can be sealed under vacuum, placed in a sealed container and put into a shaking oven, heated to the temperature 143° C. After about 20 hrs, the reactor can be cooled in liquid nitrogen, opened, weighed and placed in an ice-bath for about 60 min. About 0.0023 g of non-reacted PFP can be progressively released (the conversion of the monomer can be about 24.5 wt %). The reaction mixture can be analyzed by GC. The total product ((EtO)₂P(O)[CF₂CH(CF₃)]ₙH with n=1, 2, 3 . . . ) can comprise (assessed by GC): 34.8 wt % of non-reacted HP(O)(OEt)₂; 16.2 wt % of H₂C(CF₃)—CF₂—P(O)(OEt)₂ monoadduct (RT=7.6 min); 8.6 wt % of diadduct (RT=10.4 min); 3.3 wt % of triadduct (RT=13.9 min) and n≧4 as a residue.

### EXAMPLE 8

### Telomerization of 2H-pentafluoropropene with 1,2-dibromo-2-chlorotrifluoroethane BrCF₂CFClBr as a Telogen

Utilizing the reactor of example 9, about 0.017 g (0.00012 mole) of DTBP, 1 ml of CH₃CN as a solvent and 0.89 g (0.0032 mole) of BrCF₂CFClBr can be loaded in the reactor. About 0.3038 g PFP (0.00227 mole) can be provided to the reactor from the calibrated line. The reaction mixture can be analyzed by GC. The total product (BrCF₂CFCl[CF₂CH(CF₃)]ₙBr with n=1, 2, 3 . . . ) mixture (assessed by GC) can comprise: 22.7 wt % of non-reacted BrCF₂CFClBr; 1.8 wt % of monoadduct (n=1) BrCF₂CFClCF₂CHBrCF₃ (RT=3.2 min); 0.8 wt % of diadduct (n=2, RT=5.1 min); and n≧3 as a residue.

### EXAMPLE 9

### Radical Telomerization of 2H-pentafluoropropene with bromotrichloromethane BrCCl₃ as a Telogen

Utilizing the reactor of example 9, about 0.017 g (0.000122 mole) of DTBP, 1 ml of CH₃CN as a solvent, and 0.638 g (0.0032 mole) of BrCCl₃ can be provided to the reactor. About 0.3038 g (0.00227 moles) PFP can be provided to the reactor. Upon expiration of about 20 hours of maintaining the reactor at about 40° C., the reaction mixture can be cooled and analyzed by GC. The total product (Cl₃C[CF₂CH(CF₃)]ₙBr with n=1, 2; 0.9 wt % of monomadduct (n=1)) mixture (assessed by GC) can comprise: 77.8 wt % of non-reacted BrCCl₃; 0.3 wt % of monoadduct (n=1) Cl₃CCF₂CH(CF₃)Br (RT=3.6 min); 0.3 wt % of diadduct (n=2, RT=4.61 min); and n≧3 as a residue.

### EXAMPLE 10

### Radical Telomerization of 2H-pentafluoropropene with chloroform CHCl₃ and CH₃CN as a Solvent

In the same reactor used in example 1, the rector can be charged with 38.4 g (0.32 moles) of CHCl₃, 1.7 g (0.012 mole) of DTBP and 100 ml CH₃CN. About 30.0 g (0.23 mole) of PFP can be provided to the reactor. The pressure can be observed to reach 26 bar and stabilize to about 24.2 bar in 20 hrs. About 23.1 g of PFP remained non-reacted (degree of conversion can be about 22.9 wt %). About 11.4 g of what can be observed as a brown liquid can be acquired and distilled (Y_{d}=13.6 wt %). The total product (Cl₃C[CF₂CH(CF₃)]ₙH with n=1, 2, 3 . . . ) mixture (assessed by GC) can comprise: CHCl₃ and CH₃CN=18.1%; 27.1 wt % of HCF₂CH(CF₃)CCl₃ monoadduct (RT=2.1 min), 12.0% of PFP monoadduct (RT=2.2-2.3 min, b.p.=48-50° C. at 20 mm Hg), 6.1 wt % of diadduct (n=2, RT=4.8 min.), 4.3% of triadduct (n=3, RT=7.6 min) and n≧4 as a residue.

¹H NMR (CDCl₃, ppm): δ: centr. 4.0-C*H(CF₃); 2.0-CH₂(CF₃).

¹⁹F NMR (CDCl₃, ppm): δ: −68.5 (Cl₃CCF₂—); −61.6 (CF₃CH₂—); −110.2 (—CF_{A}F_{B} of PFP); −114.2 (HCF₂—).

### EXAMPLE 11

### Radical Telomerization of 2H-pentafluoropropene with mercaptoethanol HSCH₂CH₂OH and CH₃CN as a Solvent

In the same reactor used in example 1, the reactor can be charged with 11.8 g (0.15 mole) of HSCH₂CH₂OH, 1.1 g (0.0076 mole) of DTBP and 130 ml CH₃CN. About 20.0 g (0.15 mole) of PFP can be loaded in the reactor. The pressure can observed to be about 23.1 bar and stabilize to about 17.4 bar during 20 hours. About 8.6 g of PFP remained non-reacted (degree of conversion 57 wt %). About 24.3 g of what can be observed as a dark brown liquid can be acquired and distilled (Y_{d}=78.4 wt %). The total product mixture (assessed by GC) can comprise: HSCH₂CH₂OH=45.5 wt. %; 48.9 wt. % of CH₂(CF₃)CF₂SCH₂CH₂OH and HCF₂CH(CF₃)SCH₂CH₂OH monoadduct isomers (RT=6.5 min), 3.4 wt. % of diadduct (n=2, RT=14.7 min), and n≧3 as a residue.

¹H NMR (CDCl₃, ppm): δ: centr. 6.2 (HCF₂—); 4.4-4.2 (CF₂C*H(CF₃); 3.5 (HOCH₂CH₂); 3.0 (—C*H(CF₃)H); 2.7-2.5 (—CH₂S); m 1.2 (HS of thiol).

¹⁹F NMR (CDCl₃, ppm): δ: −61.8 (CF₃CH₂—); −63.45 (HCF₂(CF₃)—); q (63.44, 63.46, 63.48, 63.50) (—CH₂SCF₂CH₂CF₃); −72.0 (—SCF₂—); absence of AB system at −116.

### EXAMPLE 12

### Radical Cotelomerization of 3,3,3,-trifluoropropene (TFP) with vinylidene fluoride (VDF) in the presence of i-C₃F₇I

A 160-mL Hastelloy (HC-276) autoclave reactor, equipped with inlet and outlet valves, a manometer and a rupture disc, utilized as a reactor can be degassed and pressurized with about 30 bar of nitrogen to check for potential leaks. About a 7 mm Hg vacuum can be established in the reactor for about 30 min. About 1.57 g (0.009 mol) of tert-butylperoxypivalate and 10 g (0.034 mol) of i-C₃F₇I, and 100 g of 1,1,1,3,3-pentafluorobutane can be provided to the reactor to form a mixture. About 10 g (0.1 mol) of TFP and then 15 g (2.34 10⁻¹ mol) of VDF can be provided to the mixture within the reactor. The reactor can be progressively heated to 75° C., with an exotherm observed at about 80° C. and an increase of pressure from 13 bar up to 17.5 bar and a drop of pressure until stabilizing at about 5 bar. The reactor can be placed in an ice bath for about 60 minutes and 13.7 g of unreacted gaseous monomers can be progressively released (the overall conversion was 51%). After opening the autoclave reactor, about 125 g of what can be observed as a yellow liquid can be obtained. After evaporation of 1,1,1,3,3-pentafluorobutane, the total product mixture can be precipitated from cold pentane. What can be observed as a white viscous oil can be obtained according to the content of the copolymers that can be characterized by ¹⁹F and ¹H NMR spectroscopy.

### EXAMPLE 13

### Ethylenation of Telomers Containing Vinylidene Fluoride (VDF) and 3,3,3-trifluoropropene (TFP)

Utilizing a 160-mL Hastelloy (HC-276) autoclave reactor, equipped with inlet and outlet valves, a manometer and a rupture disc, as a reactor, and degassing, pressurized with about 30 bar of nitrogen to check eventual leaks, about a 7 mm Hg vacuum can be established for about 30 min. About 3.3 g (0.014 mol) of tert-butylperoxyvalate and 16.0 g of tert-butanol can be provided to the reactor. About 3.0 g (0.14 mol) of ethylene can be introduced to the mixture within the reactor. The reactor can be progressively heated to 80° C. and an exotherm to about 80° C. may be observed as well as an increase of pressure from about 4.7 bar up to 7.8 bar with stabilization of pressure to about 4 bar. After reaction, the autoclave can be placed in an ice bath for about 60 minutes and 0.8 g of unreacted ethylene can be progressively released (the conversion of ethylene can be 77%). After opening the autoclave, about 65.0 g of what can be observed as a brown liquid can be obtained. The latter can be transferred to a separating funnel, distilled water added to form a multiphase mixture from which an organic phase can be separated from an aqueous phase. The organic phase can collected, dried in the presence of MgSO₄ and filtered. The total product mixture can be distilled and the fractions characterized by gas chromatography (the pure fractions can be analyzed by ¹⁹F and ¹H NMR spectroscopy (b.p.=40-41° C./1 mm Hg and the yield can be about 66%).

The telomers and derivatives thereof can be used alone and/or in combination with or even incorporated with other compounds and used for the treatment and/or construction of paper materials. The telomers and derivatives can also be used to prepare polymer solutions. Polymeric solutions can be prepared as an aqueous or non-aqueous solution and then applied to substrates to be treated, such as paper plates.

Derivatives of the telomers can include acrylics, for example, that can be applied to finished carpet or incorporated into the finished carpet fiber before it is woven into carpet. The telomers can be applied to carpet by a normal textile finishing process known as padding, in which the carpet is passed through a bath containing the telomer or its derivative and, for example, latex, water, and/or other additives such as non-rewetting surfaces. The carpet can then be passed through nip rollers to control the rate of the add-on before being dried in a tenter frame.

Telomers and their derivatives can be used to treat substrates including hard surfaces like construction materials such as brick, stone, wood, concrete, ceramics, tile, glass, stucco, gypsum, drywall, particle board, and chipboard. These compositions and mixtures can be used alone or in combination with penetration assistance such as non-ionic surfactants. These compositions can be applied to the surface of calcitic and/or siliceous architectural construction material by known methods, for example, by soaking, impregnation, emersion, brushing, rolling, or spraying. The compositions can be applied to the surface to be protected by spraying. Suitable spraying equipment is commercially available. Spraying with a compressed air sprayer is an example method of application to the particular substrate.

Telomers and their derivatives may be used as surfactants as well. According to example embodiments, these surfactants may be used in a variety of commercial applications including but not limited to Aqueous Film Forming Foam applications.

The following are spectra associated with the previous examples.

1. A telomer composition comprising at least one taxogen unit and a telogon unit, the taxogen unit being one or more of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, and propylene; the telogen unit being one or more of R_{F}Q or R_{Cl}Q, wherein the R_{F} group can be an alkyl group having at least four fluorine atoms, the R_{Cl} group can be —CCl₃, and the Q group can be H, Br, or I.

2. The composition of claim 1 wherein the telogen unit is one of

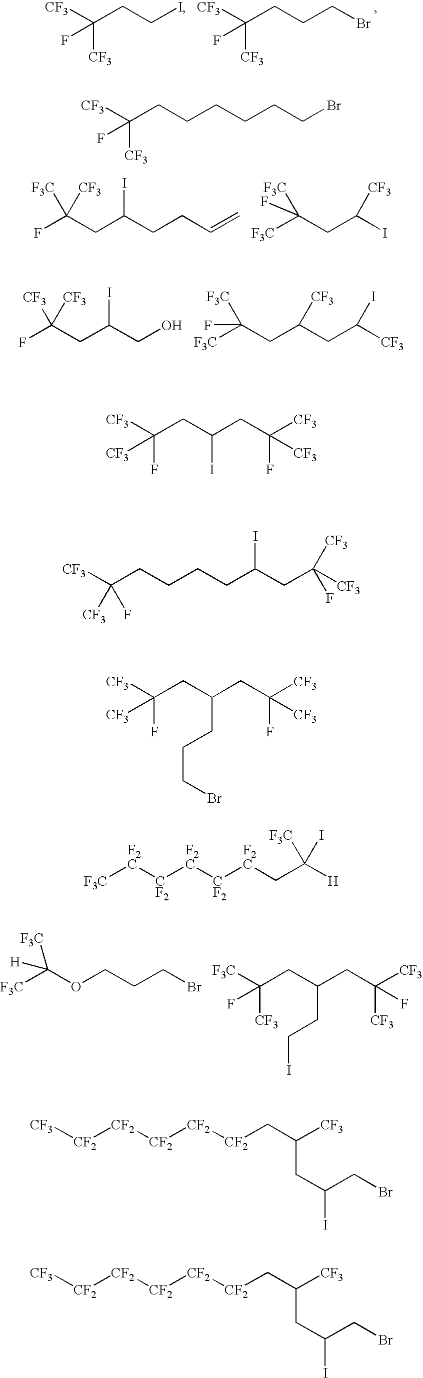

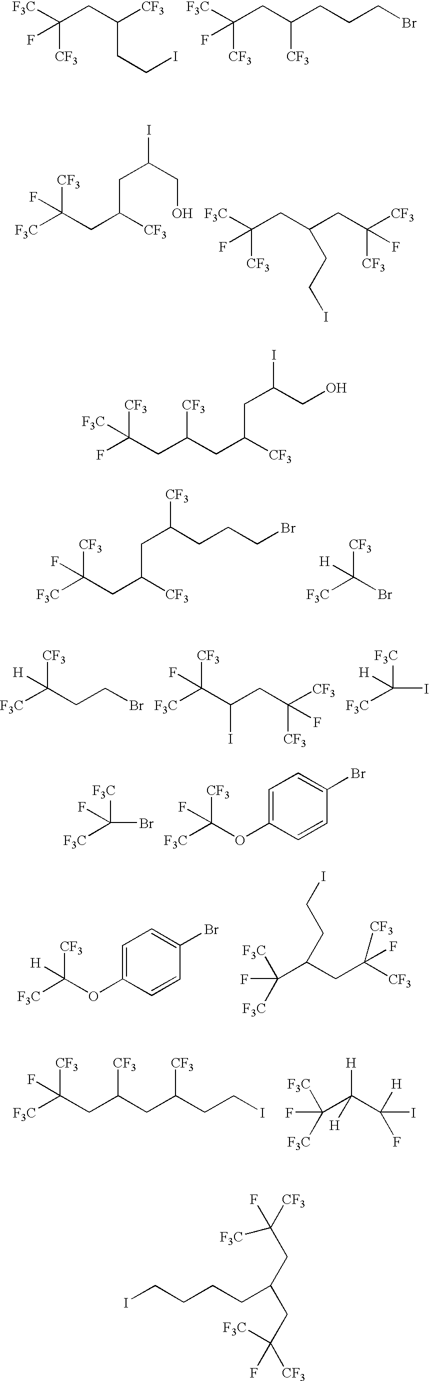

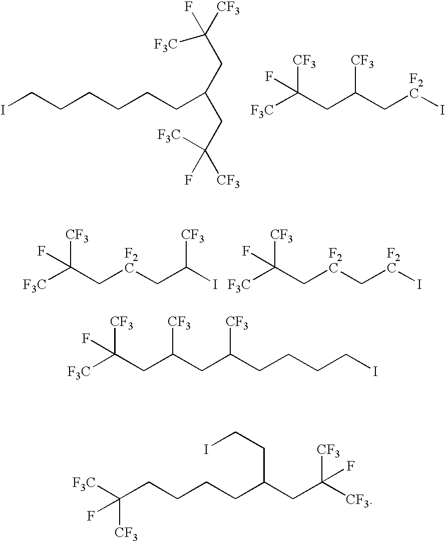

3. The composition of claim 1 containing more than one taxogen unit.

4. The composition of claim 3 containing PFP and TFP taxogen units.

5. A telomer composition comprising a taxogen unit and a telogen unit, the telogen unit comprising one of the following:

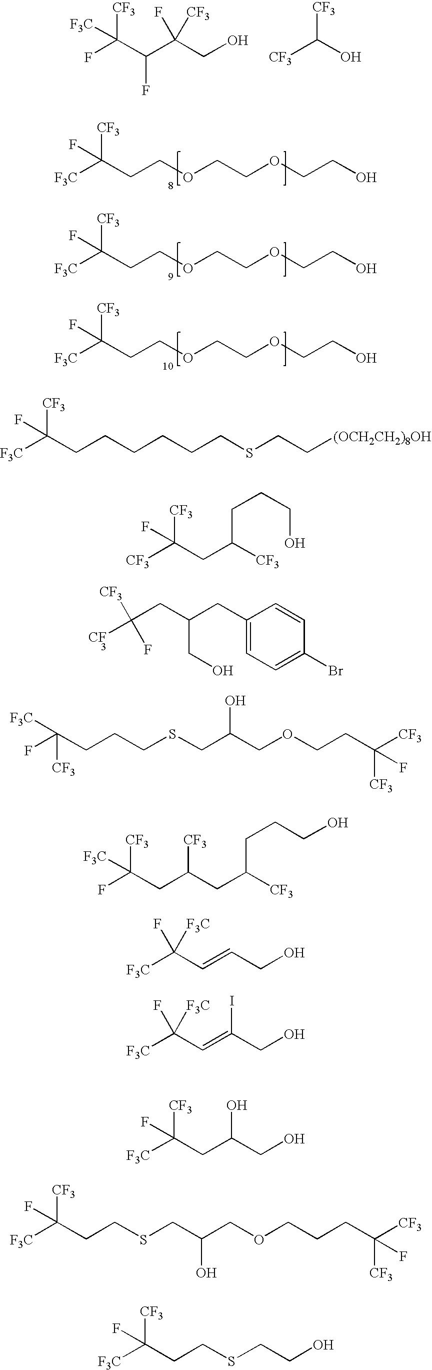

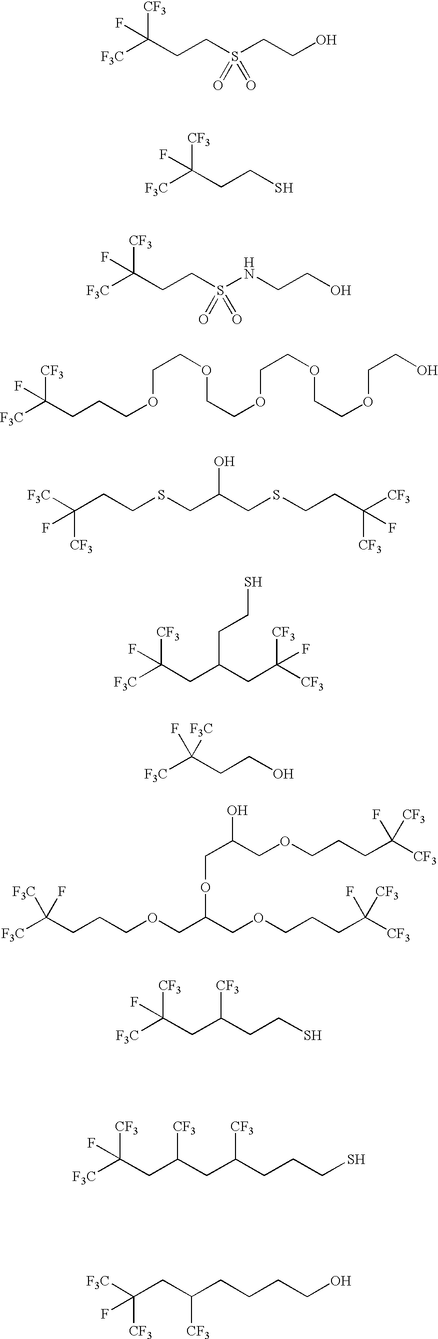

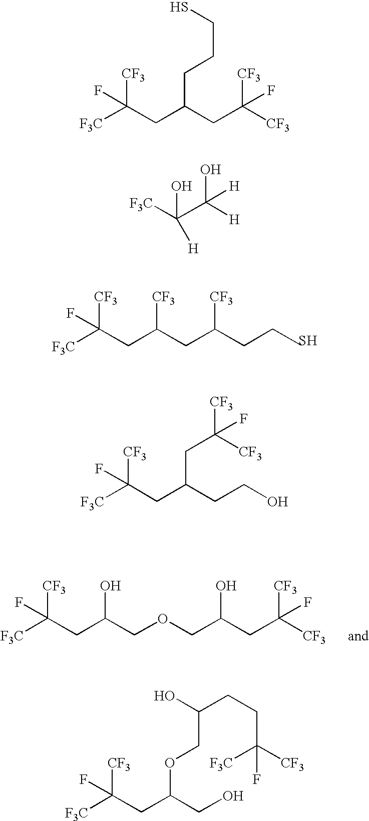

6. The telomer composition of claim 5 wherein the taxogen unit is one of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, and propylene units.

7. A chemical production process comprising exposing a taxogen to a telogen to form a telomer, wherein:
the taxogen is one or more of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, propylene, 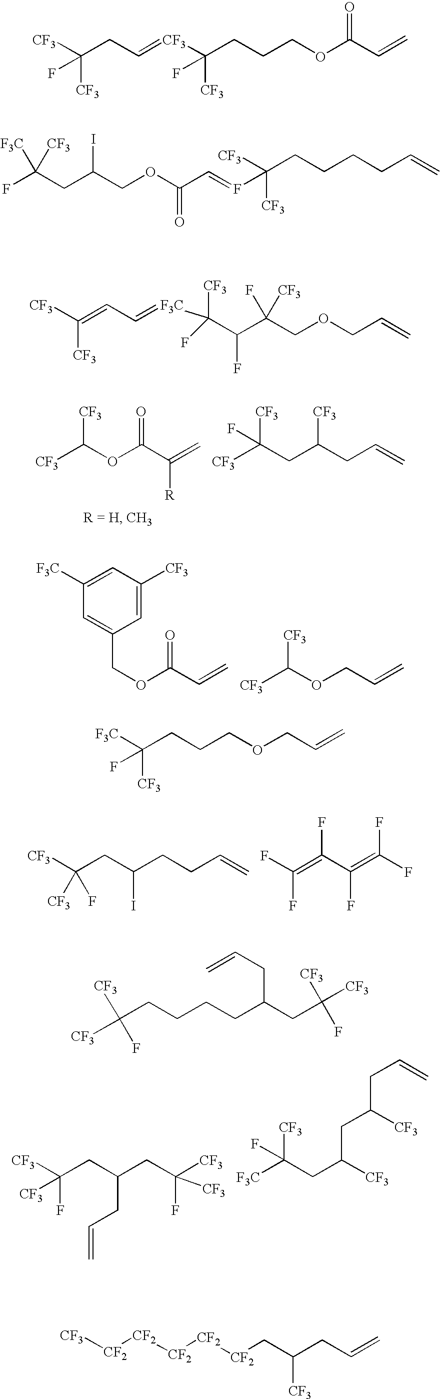 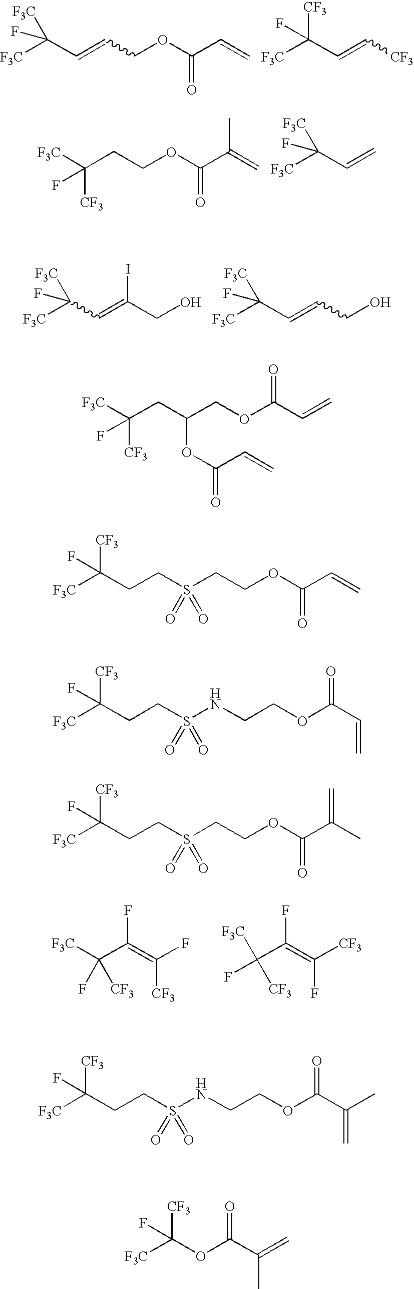 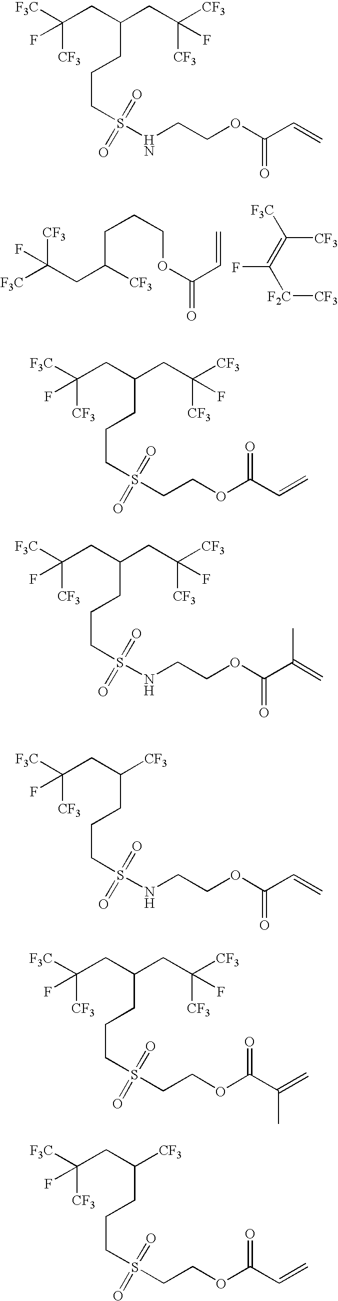 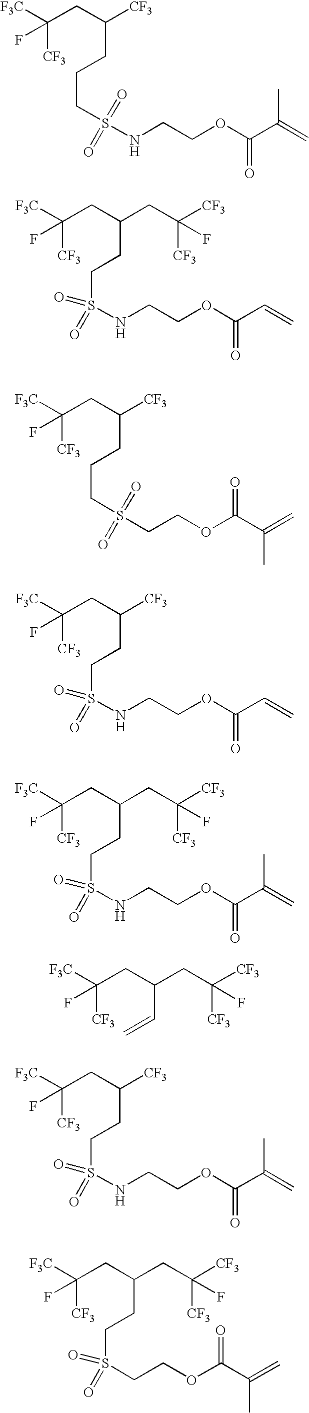 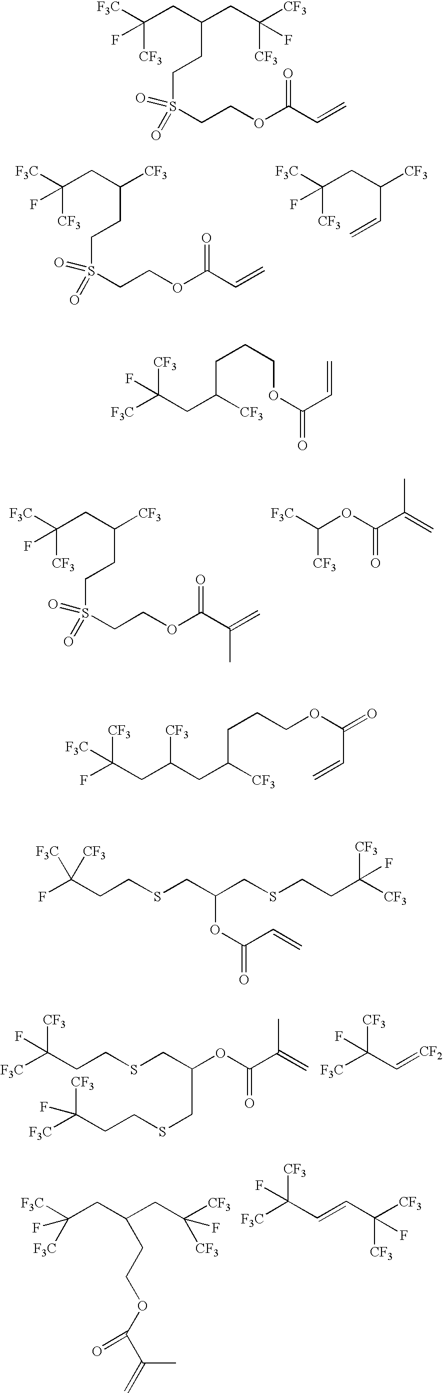 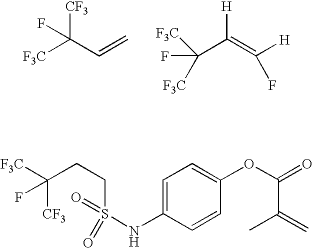
the telogen is one of

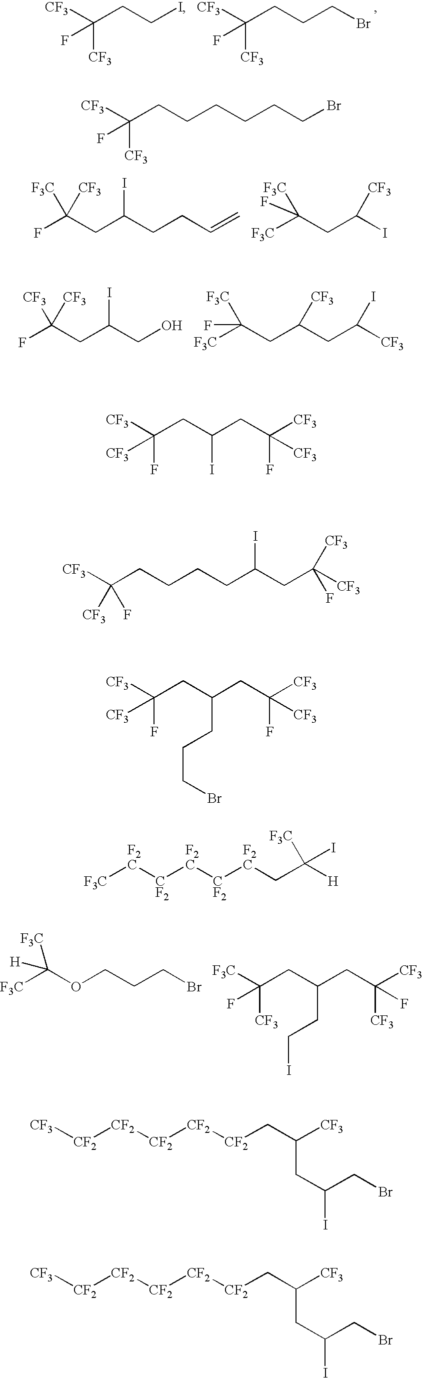

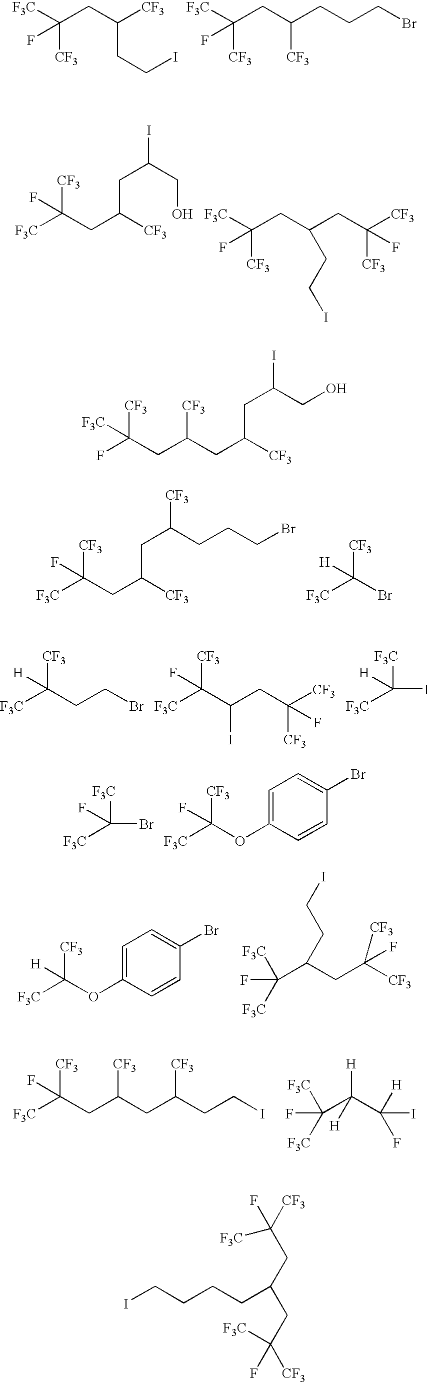

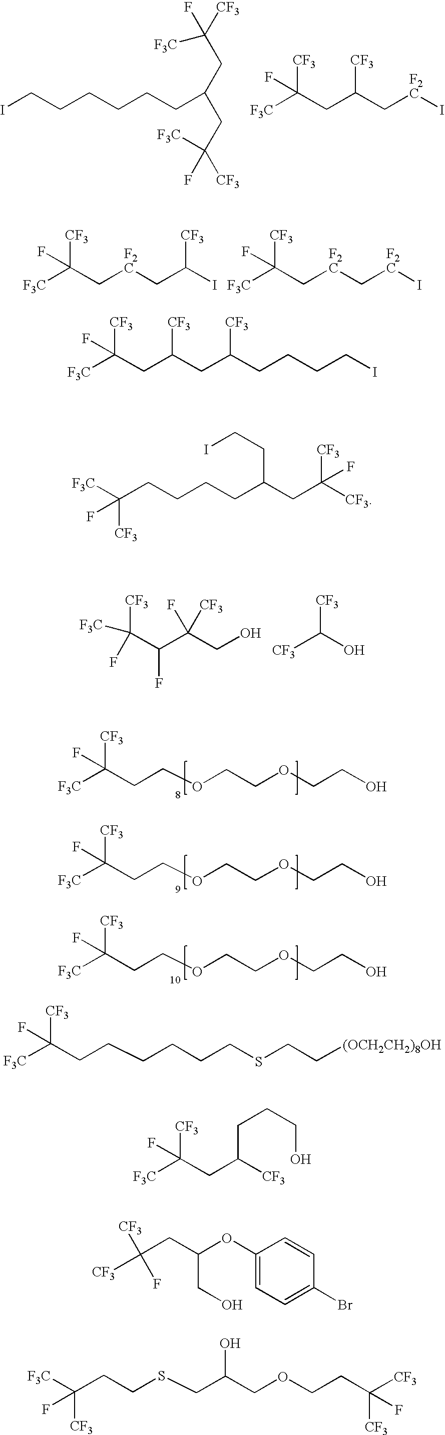

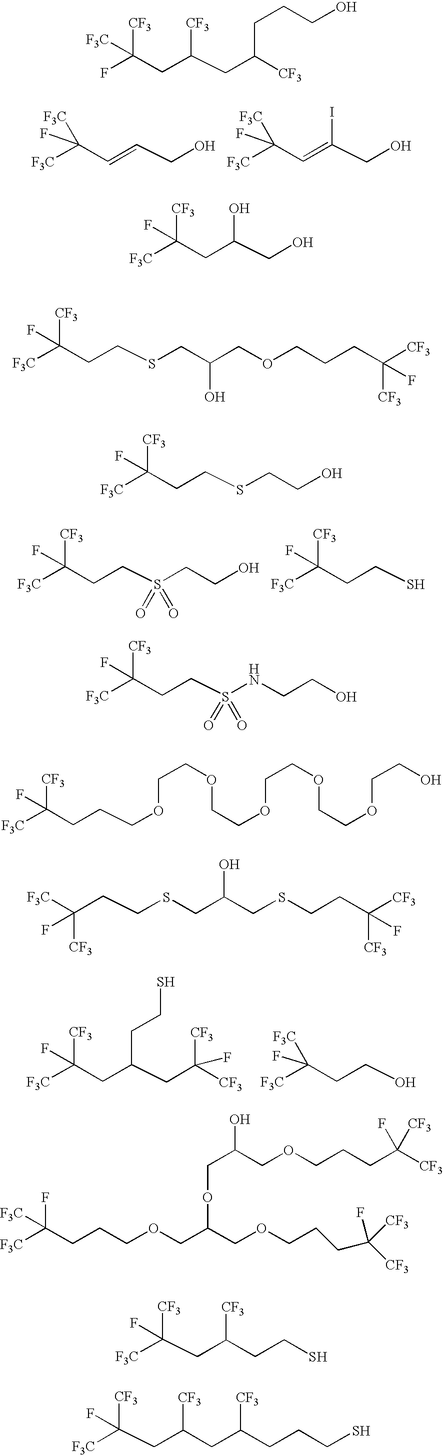

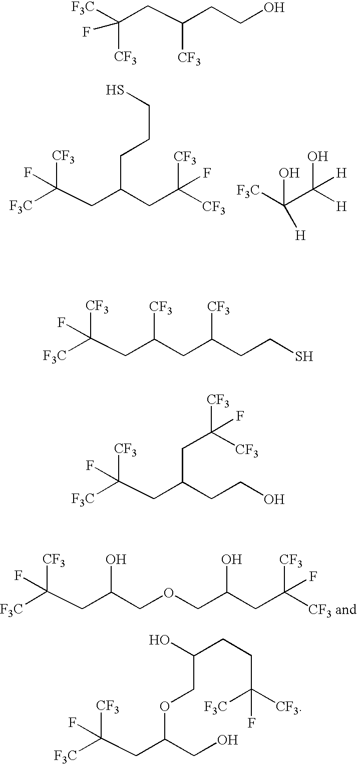

8. The process of claim 7 wherein the taxogen is exposed to the telogen in the presence of a photochemical or metal-complex initiator.

9. The process of claim 7 wherein taxogen is exposed to the telogen in the presence of DTBP.

10. The process of claim 7 wherein:
the taxogen is one or more of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, propylene; and
the telogen is one of

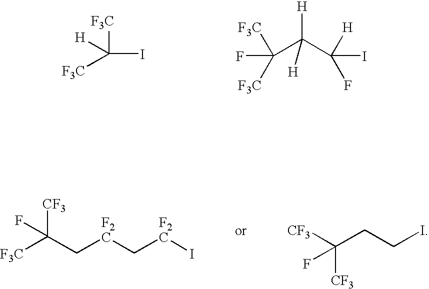

11. The process of claim 7 wherein the taxogen is at least two of TFP, PFP, VDF, TFMA, PMVE, VF, TFE, CTFE, BrTFE, HFP, dichlorodifluoroethylene, chlorodifluoroethylene, bromodifluoroethylene, ethylenealkyl ether, ethylene, propylene, and the telomer comprises cotelomer having at least two different taxogen units.

12. The process of claim 11 wherein the taxogen is both PFP and TFP and the telogen is C₆F₁₃I.

13. The process of claim 11 wherein the taxogen is both PFP and TFMA and the telogen is C₆F₁₃I.

14. The process of claim 11 wherein the taxogen is both PFP and PMVE and the telogen is C₆F₁₃I.

15. The process of claim 11 wherein the taxogen is PFP, VDF, and TFMA and the telogen is C₆F₁₃I.

16. The process of claim 11 wherein the taxogen is PFP and the telogen is diethyl phosphate.

17. The process of claim 11 wherein the taxogen is PFP and the telogen is dibromo-2-chlorotrifluoroethane.

18. The process of claim 11 wherein the taxogen is PFP and the telogen is bromotrichloromethane.

19. The process of claim 11 wherein the taxogen is PFP and the telogen is chloroform.

20. The process of claim 11 wherein the taxogen is PFP and the telogen is mercaptoethanol.

21. The process of claim 11 wherein the taxogen is both TFP and VDF and the telogen is C₃F₇I.
